(19) United States
(12) Patent Application Publication
(10) Pub. No.: US 2007/0042275 A1
(43) Pub. Date: Feb. 22, 2007

(54) Composition for optical recording, optical recording medium, and production method thereof

(75) Inventor: Makoto Kamo, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/506,812

(22) Filed: Aug. 21, 2006

(30) Foreign Application Priority Data
Aug. 22, 2005 (JP) 2005-239718

(51) Int. Cl. G03H 1/04

(52) U.S. Cl. 430/1; 430/2; 359/3; 430/281.1

(57) ABSTRACT

The invention relates to a composition for optical recording including: a matrix polymer formed by mixing an epoxide compound and a curing agent; a polymerizable monomer having an unsaturated carbon bond; and a photopolymerization initiator, wherein the curing agent includes at least one selected from a carboxylic acid, a carboxylic anhydride, a polyamide, a blocked compound of carboxylic compound, a blocked compound of carboxylic anhydride compound, a blocked compound of polyamide compound, a carboxylic acid derivative, a carboxylic anhydride derivative, and a polyamide derivative; and to an optical recording medium in which the composition for optical recording is employed and a production method thereof.

### BACKGROUND OF THE INVENTION

1. Field of the Invention

The present invention relates to a composition for optical recording that is used for optical recording media, in which information is recorded by holography, that is highly sensitive, and that enables high multiplexing recording, and relates to an optical recording medium and production method thereof.

2. Description of the Related Art

An optical recording medium is one of the recording media into which large information can be written. Among the optical recording media, for example, rewritable optical recording media such as a magnetic optical disc and phase change optical disc, and write-once optical recording media such as CD-R have been put into practice; however, further large-capacity optical recording media have been demanded. Conventional optical recording media record information two-dimensionally. Thus, there is a limitation in increasing the recording capacity. Therefore, in recent years, attention has been made in optical recording media employing a composition for optical recording corresponding to a hologram type where information can be recorded three-dimensionally.

For example, Japanese Patent Application Laid-Open (JP-A) No. 2004537620 discloses recording articles including a process and a composition for optical recording, wherein isocyanate and polyols are employed and reacted with each other to form polyurethane polymer in a system. At the time when a recording layer is disposed, the polyurethane polymer is fluid and then spontaneously cured. Thus, it is possible to form a recording layer with a desired thickness required for hologram.

In the matrix-forming system employing isocyanate, however, the isocyanate is hydrolyzed extremely easily, and carbon dioxide and amines are generated by hydrolysis reaction. Thus, for example, generated carbon dioxide causes bubble-like failure in the layer or reaction is rapidly accelerated by the generated amine, generating unexpected heat, which causes a problem that handling such as storage and management of liquids or lot control after mixing is extremely difficult. In addition, there is another drawback in that the shrinkage due to curing is high and applicable production method is very limited.

As a similar matrix-forming system, JP-A No. 11-352303 discloses a method using the reaction of an epoxy compound and, a mercaptan compound or polyamine compound. In this system, there are advantages in that the compound is not so readily hydrolyzed and that even if hydrolysis has taken place, gas generation and undesirable acceleration of curing do not occur. In addition, it is generally regarded that shrinkage induced by the curing is relatively low and the resulting optical recording medium has dimensional stability.

However, the mercaptan compound and polyamine compound generally have high reactivity with the epoxide compound, causing a problem that mixture cannot be stored for a long time as in the case of the matrix-forming system employing isocyanate. Furthermore, the mercaptan compound and the polyamine compound give off an extremely unpleasant foul smell, and in particular, the polyamine compound is concerned with its environmental toxicity.

Thus, a composition for optical recording which can form easily a recording layer with a thickness enabling high multiplexing recording, of which coating solution is easily managed, and which does not bring a foul smell and is not environmentally toxic, an optical recording medium that comprises such composition for optical recording, and a production method thereof have not been realized yet and are desired.

### SUMMARY OF THE INVENTION

An object of the invention is to solve conventional problems mentioned above and to achieve the following objects. Specifically, an object of the present invention is to provide an excellent composition for optical recording which can form easily a recording layer with a thickness enabling high multiplexing recording, of which coating solution is easily managed, and which does not bring a foul smell and is not environmentally toxic and to provide an optical recording medium that includes such composition for optical recording and a production method thereof.

The composition for optical recording of the invention includes: a matrix polymer formed by mixing an epoxide compound and a curing agent; a polymerizable monomer having an unsaturated carbon bond; and a photopolymerization initiator, wherein the curing agent includes at least one selected from a carboxylic acid, a carboxylic anhydride, a polyamide, a blocked compound of carboxylic compound, a blocked compound of carboxylic anhydride compound, a blocked compound of polyamide compound, a carboxylic acid derivative, a carboxylic anhydride derivative, and a polyamide derivative.

The optical recording medium of the invention includes a recording layer that includes the composition for optical recording of the invention.

The optical recording method of the invention includes: applying information light and reference light, which are coherent, onto the optical recording medium of the invention; forming an interference image by means of the information light and the reference light; and recording the interference image on the optical recording medium.

The optical recording apparatus of the invention is an apparatus wherein information light and reference light, which are coherent, are applied onto the optical recording medium of the invention, an interference image is formed by means of the information light and the reference light, and the interference image is recorded on the optical recording medium.

The method for producing an optical recording medium of the invention includes a step of preparing the composition for optical recording of the invention and a step of disposing a recording layer, which includes the composition for is optical recording, on a base material.

### BRIEF DESCRIPTION OF THE DRAWINGS

FIG. 1 is a partial cross-sectional view of an optical recording medium.

FIG. 2 is a partial cross-sectional view of a disc type optical recording medium.

FIG. 3 is a schematic cross-sectional view showing an example of a conventional optical recording medium.

FIG. 4 is a graph showing reflection characteristics of a cholesteric liquid crystal layer.

FIG. 5 is a graph showing the number of cholesteric liquid crystal layers to be laminated and reflection characteristics.

FIG. 6 is a graph showing the number of cholesteric liquid crystal layers to be laminated and reflection characteristics.

FIG. 7 is a graph showing the number of cholesteric liquid crystal layers to be laminated and reflection characteristics.

FIG. 8 is a schematic cross-sectional view showing an example of the optical recording medium according to an embodiment of the invention.

FIG. 9 is an explanatory diagram showing an example of the optical system around the optical recording medium according to the first form.

FIG. 10 is an explanatory diagram showing an example of the optical system around the optical recording medium according to the second form.

FIG. 11 is a block diagram showing an example of the entire configuration of the optical recording and reproducing apparatus according to the second form.

### DESCRIPTION OF THE PREFERRED EMBODIMENTS

(Composition for Optical Recording)

The composition for optical recording of the invention is a composition for optical recording that comprises a matrix polymer formed by mixing an epoxide compound and a curing agent, a polymerizable monomer having an unsaturated carbon bond, and a photopolymerization initiator, and may further comprise additional compounds provided on an as-needed basis.

—Matrix Polymer—

The matrix polymer is obtained by mixing the epoxide compound and the curing agent, followed by an in-situ matrix-forming reaction, which allows for the formation of a thick film. The above-mentioned “mix” refers to coalesce or agitate an epoxide-containing composition and curing agent-containing composition, which are separately prepared, to thereby obtain a uniform composition. This mixing allows the epoxide compound and curing agent to be contained in the same composition, virtually creating a state capable of undergoing curing reaction. When the composition at this state is treated for a given time under a certain temperature condition, the epoxide compound and curing agent undergo a chemical reaction in the composition, resulting in the formation of the gel-like matrix polymer. By the time at which liquids are mixed, and during the time from mixing to the end of the above-mentioned chemical reaction, materials are not readily hydrolyzed and are easy to handle, making it easier to manage the liquids.

The “gel” described here refers to “a polymer solid or swollen body thereof, which dose not dissolve into any solvent and has a three-dimensional structure”.

As the matrix polymer, such a matrix polymer is used that is formed by the epoxide compound, curing agent and curing catalyst, which will be described later. The matrix polymer may be formed of a plurality of epoxide compounds and a plurality of curing agents, but it is preferable that the matrix polymer is composed of a uniform and single phase as a whole. Whether or not the matrix polymer is composed of a uniform and single phase can be determined based on the following criteria: glass transition point is measured by a variety of measuring methods and determine based on whether the value is single or not, or Rayleigh ratio is measured and determine based on whether or not the Rayleigh ratio in 90° light scattering of a wavelength effective for hologram formation is about 7×10⁻³ or less. Alternatively, the criterion may be such that no refractive index modulation due to the phase separation of matrix polymer is found when observed with a laser microscope.

The ratio of the contents of the epoxide compound and the curing agent in the total solid components of the matrix polymer is not particularly limited and can be appropriately set depending on the intended purpose. For example, when the epoxide compound is set to 1, the curing agent is preferably in the range of 0.5 to 1.5, more preferably in the range of 0.7 to 1.3, and most preferably in the range of 0.8 to 1.2. This range prevents unreacted epoxide or curing agent from remaining excessively after the curing reaction. As a result, for example, a problem that the flow of matrix polymer itself makes it impossible to keep the intended shape can be avoided. In addition, harmful effect that the epoxide compound or curing agent is decomposed or degraded with time, resulting in the loss of function as a composition for optical recording can be avoided. The content of the matrix polymer is preferably 60% by mass to 98% by mass, more preferably 70% by mass to 95% by mass, and most preferably 80% by mass to 90% by mass of the total solid components of the composition for optical recording. Within this range, such phenomenon that the entire recording layer becomes fluid due to other components, making it impossible to keep the intended shape and the shape of the recorded refractive index image, can be prevented. In addition, the composition can comprise sufficient polymerizable monomer, thus enabling the enhancement of multiplexing recording performance.

—Epoxide Compound—

The epoxide compound is a compound including glycidyl ethers, glycidyl esters, glycidyl amines, alkyl oxides which are synthesized by the oxidation of unsaturated hydrocarbon, and derivatives of these compounds. For preventing the epoxide compound from turning yellow with time, it is desirable that the epoxide compound does not comprise an aromatic ring. Specific examples of glycidyl ethers include diglycerol polyglycidyl ether, pentaerythritol polyglycidyl ether, 1,4-bis(2,3-epoxypropoxy perfluoroisopropyl)cyclohexane, sorbitol polyglycidyl ether, trimethylolpropane polyglycidyl ether, resorcin diglycidyl ether, 1,6-hexanediol diglycidyl ether, polyethylene glycol diglycidyl ether, phenyl glycidyl ether, p-tert-butylphenyl glycidyl ether, adipic acid diglycidyl ester, o-phthalic acid diglycidyl ester, dibromophenyl glycidyl ether, dibromoneopentyl glycol diglycidyl ether, 1,2,7,8-diepoxyoctane, 1,6-dimethylol perfluorohexane diglycidyl ether, modified polyethylene oxide and modified polypropylene oxide of these compounds, polyethylene glycol diglycidyl ether, polypropylene glycol diglycidyl ether, polytetrahydrofuran diglycidyl ether, polyethylene glycol triol triglycidyl ether, polypropylene glycol triol triglycidyl ether.

Examples of the glycidyl esters include glycidyl esters of hydrogenated products of aromatic dicarboxylic acids such as tetrahydrophthalate, is hexahydrophthalate, methylated hexahydrophthalate, hexahydroterephthalate, and hexahydropyromellitic acid; glycidyl ester compounds of aliphatic dicarboxylic acids such as succinic acid, alkenyl succinic acid, nagic acid, methyl nagic acid, maleated fatty acid, dodecenyl succinic acid, adipic acid, azelaic acid, sebacic acid, dodecane dicarboxylic acid, and eicosane dicarboxylic acid; and modified polyethylene oxide and modified polypropylene oxide of these compounds.

Examples of the glycidyl amines include bifunctional or trifunctional glycidyl amines prepared by the reaction of aliphatic multifunctional amines such as polymethylene diamine and epichlorohydrin; and multifunctional glycidyl amines prepared by the reaction of polyamines such as polyetherdiamine, diethylene triamine, bishexamethylene triamine, triethylene tetramine, tetraethylenepentamine, and aminoethylethanolamine, and epichlorohydrin.

For alkyl oxides which are synthesized by the oxidation of unsaturated hydrocarbon, cyclohexene oxide or a cyclohexene oxide-containing compound is preferable. Specific examples include 4,4-bis(2,3-epoxypropoxy perfluoroisopropyl)diphenylether, 3,4-epoxycyclohexylmethyl-3,4-epoxycyclohexanecarboxylate, 3,4-epoxycyclohexyloxirane, 1,2,5,6-diepoxy-4,7-methanoperhydroindene, 2-(3,4-epoxycyclohexyl)-3,4-epoxy-1,3-dioxane-5-spirocyclohexane, 1,2-ethylenedioxy-bis(3,4-epoxycylohexylmethane), 4,5-epoxy-2-methylcyclohexylmethyl-4,5-epoxy-2-methylcyclohexanecarboxylate, ethylene glycol-bis(3,4-epoxycyclohexanecarboxylate), bis-(3,4-epoxycyclohexylmethyl)adipate, di-2,3-epoxycyclopentyl ether, and the compounds listed below.

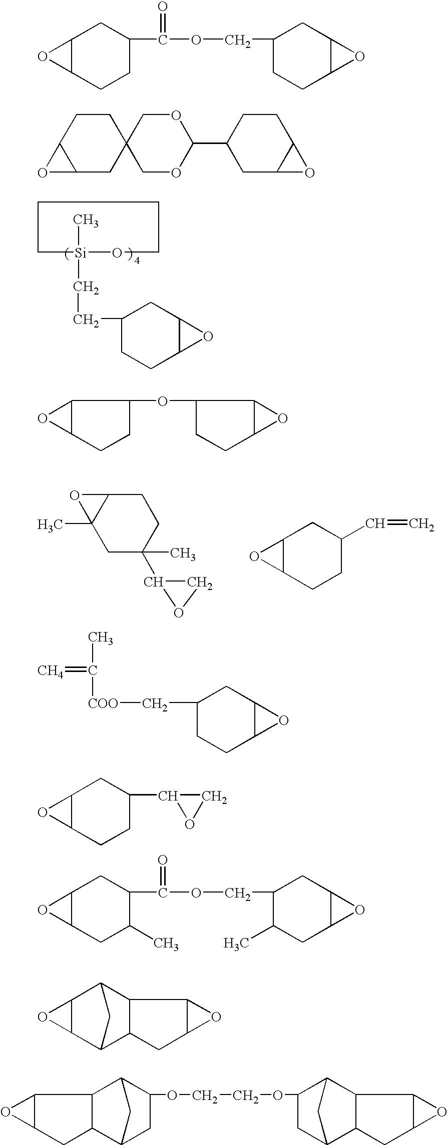

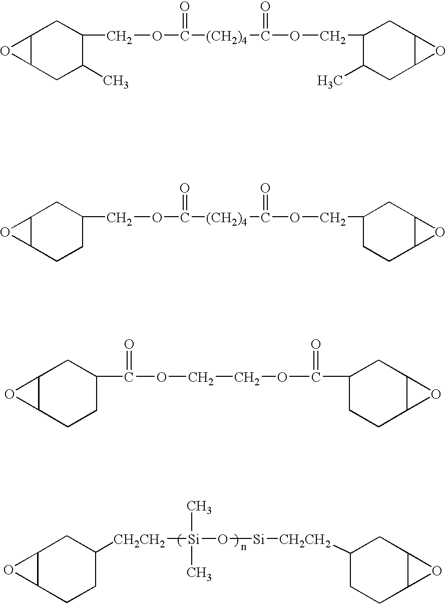

Among these, glycidyl ethers are preferably used in terms of easy availability and handling of the compounds. These compounds may be used singly or in combination.

The content of the epoxide compound in the total solid components of the composition for optical recording is not particularly limited and is determined depending on the equivalent ratio to the curing agent and on the content of the matrix polymer, formed by the reaction of the epoxide and the curing agent to be described later, in the total solid components of the composition for optical recording. In addition, the content of the epoxide compound is determined such that the resulting composition has a viscosity appropriate for the intended handling. Roughly, the content of the epoxide compound is preferably 10% by mass to 90% by mass, more preferably 20% by mass to 80% by mass. Within this range, it is possible to form a holographic recording layer with desirable mechanical properties using materials which are easily available and easy to handle.

—Curing Agent—

The curing agent is composed of a compound containing at least any one selected from carboxylic acids, carboxylic anhydrides, polyamides, blocked compounds of carboxylic compounds, blocked compounds of polyamide compounds, carboxylic acid derivatives, carboxylic anhydride derivatives, and polyamide derivatives. For preventing the matrix polymer from turning yellow with time, it is preferable that these compounds do not comprise an aromatic ring. As the carboxylic acid, dicarboxylic acids, tricarboxylic acids, tetracarboxylic acids, and the like that are described as raw materials of the glycidyl esters, are preferable. In addition, aliphatic dicarboxylic acids, aliphatic tricarboxylic acids, and aliphatic tetracarboxylic acids are also suitably employed.

Examples of the carboxylic anhydride include hydrogenated aromatic polycarboxylic anhydrides such as tetrahydrophthalic anhydride, methylated tetrahydrophthalic anhydride, hexahydrotrimellitic anhydride, hexahydropyromellitic anhydride, hexahydrophthalic anhydride, methylated hexahydrophthalic anhydride, endomethylenetetrahydrophthalic anhydride, methylbutenyltetrahydrophthalic anhydride, dodecenyl succinic anhydride, succinic anhydride, and methylcyclohexenedicarboxylic anhydride; and aliphatic polycarboxylic anhydrides such as maleic anhydride, linolenic anhydride, linoleic anhydride, eleostearic anhydride, polyadipic acid anhydride, polyazelaic acid anhydride, polysebacic acid anhydride, dodecanedicarboxylic anhydride, and eicosanedicarboxylic anhydride.

The polyamides are obtained by allowing a dimer acid, prepared by the polymerization of linoleic acid, linolenic acid, or stearic acid, to react with polyamines described as a raw material of the glycidyl amine. The polyamides are also obtained by allowing known dicarboxylic acids, tricarboxylic acids, or a variety of compounds having four carboxylic acid groups or more to react with the above-mentioned polyamines. In view of ensuring optical transparency and of preventing coloring during long-term storage, polyamide amines are preferable that are obtained by allowing the above-mentioned a dicarboxylic acid, tricarboxylic acid, or tetracarboxylic acid, which are a hydrolysate of carboxylic anhydride, to react with an aliphatic or alicyclic polyamine.

In particular, hexahydrotrimellitic anhydride, methylated hexahydrophthalic anhydride, and dodecenyl succinic anhydride are preferably employed in terms of handling and weather resistance of the matrix polymer to be formed. These compounds may be used singly or in combination.

The content of the curing agent in the total solid components of the composition for optical recording is not particularly limited and is determined depending on the equivalent ratio to the epoxide compound and on the content of the matrix polymer, formed by the reaction of the epoxide and the above-mentioned curing agent, in the total solid components of the composition for optical recording. In addition, the content of the curing agent is determined such that the resulting composition has a viscosity appropriate for the intended handling for a certain time. Roughly, the content of the curing agent is preferably 10% by mass to 90% by mass, more preferably 20% by mass to 80% by mass. Within this range, it is possible to form a holographic recording layer with desirable mechanical properties using materials which are easily available and easy to handle.

When epoxy equivalent ratio of the epoxide is set to be 1, the equivalent ratio of the functioning group of the curing agent that can react with epoxide is preferably 0.7 to 1.3, more preferably 0.8 to 1.25, most preferably 0.9 to 1.2. It is preferable to use a curing accelerator which is a curing catalyst having a function to promote curing by the curing agent.

<Curing Accelerator>

The addition of the curing accelerator enables a matrix-forming reaction to proceed at a desired heating temperature and for a desired heating time. In general, when only the epoxy compound and the curing agent are mixed, the matrix-forming reaction proceeds quite slowly, thus requiring heating at high temperature and for a long time in order to obtain the intended cured film. It is preferable that the matrix-forming reaction proceeds at a lower heating temperature and at short times in view of heat resistance of a substrate or support and stability of photopolymer components to be contained, specifically, a monomer and photopolymerization initiator.

As the curing accelerator, those that can be used as a curing catalyst of epoxy compound can be used, including organic complex salts of a variety of metals, metal salts, enamines, ammonium salts, tertiary amines, tertiary aminophenols, borates, imidazolium salts, sulfonium salts, iodonium salts, phosphonium salts, phosphorus compounds, and the like. In particular, those known as a latent catalyst are preferable. Details are described in “New Epoxy Resin” (edited by Hiroshi Kakiuchi, published by Shokodo).

These curing accelerators are 0.01 parts by weight to 10 parts by weight, preferably 0.1 parts by weight to 5 parts by weight of the total solid components of photosensitive composition. Within this range, optically stable and highly transparent cured products with excellent mechanical properties can be obtained. However, when the content of the curing accelerator is below this range, the curing accelerator does not perform its function properly. In contrast, when the content exceeds the range, mechanical properties and/or optical properties may be deteriorated.

The composition of the invention may comprise an additive for epoxy resin known in the art such as a color protection agent, antiaging agent, inorganic filler, denaturant, silane coupling agent, pigment, dye, and reactive or non-reactive diluent on an as-needed basis.

<Polymerizable Monomer>

The polymerizable monomer is a monomer having the unsaturated carbon bond and is, for example, at least one compound selected from unsaturated carboxylic esters, unsaturated carboxylic amides, styrenes, vinyl ethers, and vinyl esters.

Examples of the unsaturated carboxylic esters and amides include esters and amides of acrylic acid, methacrylic acid, itaconic acid, crotonic acid, isocrotonic acid, and maleic acid. Esters of unsaturated carboxylic acids and alcohol compounds or phenol compounds, and amides of unsaturated carboxylic acids and amine compounds or aromatic amine compounds are preferably used. Further, unsaturated carboxylic esters having a substituent such as a halogen group, or reactants of amides substituted with monofunctional or multifunctional alcohols, amines, or thiols are also preferably used.

Specific examples of the monomer of the esters of unsaturated carboxylic acids and alcohol compounds or phenol compounds are as follows: examples of acrylic acid ester include ethylene glycol diacrylate, isocyanuric acid EO-modified triacrylate, bis[p-(3-acryloxy-2-hydroxypropoxy)phenyl]dimethyl methane, bis-[p-(acryloxyethoxy) phenyl]dimethyl methane, benzyl acrylate, 2-phenoxyethyl acrylate, naphthyl acrylate, isobornyl acrylate, tribromophenyl acrylate, tribromophenoxyethyl acrylate, dibromophenyl acrylate, p-chlorophenyl acrylate, and trichlorophenyl acrylate.

Examples of methacrylic acid ester include bis[p-(3-methacryloxy-2-hydroxypropoxy)phenyl]dimethyl methane, bis-[p-(methacryloxyethoxy)phenyl]dimethyl methane, benzyl methacrylate, 2-phenoxyethyl methacrylate, naphthyl methacrylate, isobornyl methacrylate, tribromophenyl methacrylate, tribromophenoxyethyl methacrylate, dibromophenyl methacrylate, trichlorophenyl methacrylate, and the like.

Esters in which the acrylic acid or methacrylic acid is substituted with itaconic acid, crotonic acid, isocrotonic acid or maleic acid are also suitably used.

Examples of other esters include esters having 9,9-diarylfluorene skeleton disclosed in Japanese Patent (JP-B) No. 2849021, siloxane bond-containing (meth)acrylates disclosed in JP-A No. 8-101499 and JP-B No. 3532679, biphenyl-containing (meth)acrylates disclosed in JP-A No. 2001-125474, and (meth)acrylates having a oligomer structure, disclosed in JP-A Nos. 7-199777, 7-199779, and 7-104643.

Specific examples of the monomer of amide of the amine compounds and unsaturated carboxylic acids are as follows: examples of acrylic amide include ethylene glycol diacrylamide, isocyanuric acid EO-Modified triacrylamide, bis[p-(3-acrylamino-2-hydroxypropoxy)phenyl]dimethyl methane, bis-[p-(acrylamino ethoxy)phenyl]dimethyl methane, benzyl acrylamide, 2-phenoxyethyl acrylamide, naphthylacrylamide, isobornyl acrylamide, acrylamide, tribromophenyl acrylamide, tribromophenoxyethyl acrylamide, dibromophenyl acrylamide, p-chlorophenyl acrylamide, and trichlorophenyl acrylamide.

For the methacrylic acid amide, itaconic acid amide, crotonic acid amide, isocrotonic acid amide, and maleic acid amide, those in which the above-mentioned acrylic amide is replaced with methacrylic acid amide, itaconic acid amide, crotonic acid amide, isocrotonic acid amide, or maleic acid amide are suitably used.

Examples of the styrenes include styrene, bromostyrene, chlorostyrene, dibromostyrene, dichlorostyrene, vinylnaphthalene, bromovinylnaphthalene, chlorovinylnaphthalene, divinylbenzene, and a variety of styrene derivatives.

Examples of vinyl ether compound include phenyl vinyl ether, bis[p-(3-vinyloxy-2-hydroxypropoxy)phenyl]dimethyl methane, bis-[p-(vinyloxyethoxy)phenyl]dimethyl methane, dibromophenyl vinyl ether, bromophenyl vinyl ether, resorcin divinyl ether, and bromoresorcin divinyl ether.

The content of the polymerizable monomer, relative to the total mass of the photosensitive composition, is preferably in the range of 1% by mass to 20% by mass, more preferably in the range of 2% by mass to 15% by mass, most preferably in the range of 3% by mass to 10% by mass. These compounds may be used singly or may be used by mixing two or more compounds.

<Photopolymerization Initiator>

The photopolymerization initiator is not particularly limited and a variety of systems known in the art can be employed. Initiator system may be a system consisting of a single compound or may be a system consisting of two or more compounds. A single initiator system may perform a system activating a radical polymerization and a system activating a cationic polymerization or ring-opening polymerization, or two different initiator systems may perform each system.

A photoacid-generator is preferable for the photocationic polymerization or ring-opening polymerization initiator. Examples of the photoacid generator include trichloromethyl-s-triazines, diaryliodonium salts, triarylsulfonium salts, quaternary ammonium salts, and sulfonic esters.

Examples of the trichloromethyl-s-triazines include 2,4,6-tris(trichloromethyl)-s-triazine, 2-phenyl-4,6-bis(trichloromethyl)-s-triazine, 2-(4-chlorophenyl)-4,6-bis(trichloromethyl)-s-triazine, 2-(3-chlorophenyl)-4,6-bis(trichloromethyl)-s-triazine, 2-(2-chlorophenyl)-4,6-bis(trichloromethyl)-s-triazine, 2-(4-methoxyphenyl)-4,6-bis(trichloromethyl)-s-triazine, 2-(3-methoxyphenyl)-4,6-bis(trichloromethyl)-s-triazine, 2-(2-methoxyphenyl)-4,6-bis(trichloromethyl)-s-triazine, 2-(4-methylthiophenyl)-4,6-bis(trichloromethyl)-s-triazine, 2-(3-methylthiophenyl)-4,6-bis(trichoromethyl)-s-triazine, 2-(2-methylthiophenyl)-4,6-bis(trichloromethyl)-s-triazine, 2-(4-methoxynaphthyl)-4,6-bis(trichloromethyl)-s-triazine, 2-(3-methoxynaphthyl)-4,6-bis(trichloromethyl)-s-triazine, 2-(2-methoxynaphthyl)-4,6-bis(trichloromethyl)-s-triazine, 2-(4-methoxy-β-styryl)-4,6-bis(trichloromethyl)-s-triazine, 2-(3-methoxy-β-styryl)-4,6-bis(trichloromethyl)-s-triazine, 2-(2-methoxy-β-styryl)-4,6-bis(trichloromethyl)-s-triazine, 2-(3,4,5-trimethoxy-β-styryl)-4,6-bis(trichloromethyl)-s-triazine, 2-(4-methylthio-β-styryl)-4,6-bis(trichloromethyl)-s-triazine, 2-(3-methylthio-β-styryl)-4,6-bis(trichloromethyl)-s-triazine, 2-(3-methylthio-β-styryl)-4,6-bis(trichloromethyl)-s-triazine, 2-piperonyl-4,6-bis(trichloromethyl)-s-triazine, 2-[2-(furan-2-yl)ethenyl]-4,6-bis(trichloromethyl)-s-triazine, 2-[2-(5-methylfuran-2-yl)ethenyl]-4,6-bis(trichoromethyl)-s-triazine, and 2-[2-(4-diethylamino-2-methylphenyl)ethenyl]-4,6-bis(trichloromethyl)-s-triazine.

Examples of the diaryliodonium salts include diphenyliodonium tetrafluoroborate, diphenyliodonium hexafluorophosphonate, diphenyliodonium hexafluoroarsenate, diphenyliodonium trifluoromethanesulfonate, diphenyliodonium trifluoroacetate, diphenyliodonium-p-toluenesulfonate, diphenyliodonium butyltris(2,6-difluoropheny)borate, diphenyliodonium trifluoromethane sulfonate, diphenyliodonium trifluoroacetate, diphenyliodonium-p-toluene sulfonate, diphenyliodonium butyltris(2,6-difluorophenyl)borate, diphenyliodonium hexyltris(p-chlorophenyl)borate, diphenyliodonium hexyltris(3-trifluoromethylphenyl)borate, 4-methoxyphenylphenyliodonium tetrafluoroborate, 4-methoxyphenylphenyliodonium hexafluorophosphonate, 4-methoxyphenylphenyliodonium hexafluoroarsenate, 4-methoxyphenylphenyliodonium trifluoromethane sulfonate, 4-methoxyphenylphenyliodonium trifluoroacetate, 4-methoxyphenylphenyliodonium-p-toluene sulfonate, 4-methoxyphenylphenyliodonium butyltris(2,6-difluorophenyl)borate, 4-methoxyphenylphenyliodonium hexyltris(p-chlorophenyl)borate, 4-methoxyphenylphenyliodonium hexyltris(3-trifluoromethylphenyl)borate, bis(4-tert-butylphenyl)iodonium tetrafluoroborate, bis(4-tert-butylphenyl)iodonium hexafluoroarsenate, bis(4-tert-butylphenyl)iodonium trifluoromethane sulfonate, bis(4-tert-butylphenyl)iodonium trifluoroacetate, bis(4-tert-butylphenyl)iodonium-p-toluene sulfonate, bis(4-tert-butylphenyl)iodonium butyltris(2,6-difluorophenyl)borate, bis(4-tert-butylphenyl)iodonium hexyltris(p-chlorophenyl)borate, and bis(4-tert-butylphenyl)iodonium hexyltris(3-trifluoromethylphenyl)borate.

Examples of the triarylsulfonium salts include triphenylsulfonium tetrafluoroborate, triphenylsulfonium hexafluorophosphonate, triphenylsulfonium hexafluoroarsenate, triphenylsulfonium trifluoromethane sulfonate, triphenylsulfonium trifluoroacetate, triphenylsulfonium-p-toluene sulfonate, triphenylsulfonium butyltris(2,6-difluorophenyl)borate, triphenylsulfonium hexyltris(p-chlorophenyl)borate, triphenylsulfonium hexyltris(3-trifluoromethylphenyl)borate, 4-methoxyphenyldiphenylsulfonium tetrafluoroborate, 4-methoxyphenyldiphenylsulfonium hexafluorophosphonate, 4-methoxyphenyldiphenylsulfonium hexafluoroarsenate, 4-methoxyphenyldiphenylsulfonium trifluoromethane sulfonate, 4-methoxyphenyldiphenylsulfonium trifluoroacetate, 4-methoxyphenyldiphenylsulfonium-p-toluene sulfonate, 4-methoxyphenyldiphenylsulfonium butyltris(2,6-difluorophenyl)borate, 4-methoxyphenyldiphenylsulfonium hexyltris(p-chlorophenyl)borate, 4-methoxyphenyldiphenylsulfonium hexyltris(3-trifluoromethylphenyl)borate, 4-phenylthiophenyldiphenylsulfonium tetrafluoroborate, 4-phenylthiophenyldiphenylsulfonium hexafluorophosphonate, 4-phenylthiophenyldiphenylsulfonium hexafluoroarsenate, 4-phenylthiophenyldiphenylsulfonium trifluoromethane sulfonate, 4-phenylthiophenyldiphenylsulfonium trifluoroacetate, 4-phenylthiophenyldiphenylsulfonium-p-toluene sulfonate, 4-phenylthiophenyldiphenylsulfonium butyltris(2,6-difluorophenyl)borate, 4-phenylthiophenyldiphenylsulfonium hexyltris(p-chlorophenyl)borate, 4-phenylthiophenyldiphenylsulfonium hexyltris(3-trifluoromethylphenyl)borate, 4-hydroxy-1-naphthalenyl)dimethylsulfonium tetrafluoroborate, 4-hydroxy-1-naphthalenyl)dimethylsulfonium hexafluorophosphonate, 4-hydroxy-1-naphthalenyl)dimethylsulfonium hexafluoroarsenate, 4-hydroxy-1-naphthalenyl)dimethylsulfonium trifluoromethane sulfonate, 4-hydroxy-1-naphthalenyl)dimethylsulfonium trifluoroacetate, 4-hydroxy-1-naphthalenyl)dimethylsulfonium-p-toluene sulfonate, 4-hydroxy-1-naphthalenyl)dimethylsulfonium butyltris(2,6-difluorophenyl)borate, 4-hydroxy-1-naphthalenyl)dimethylsulfonium hexyltris(p-chlorophenyl)borate and 4-hydroxy-1-naphthalenyl)dimethylsulfonium hexyltris(3-trifluoromethylphenyl)borate.

Examples of the quaternary ammonium salts include tetramethylammonium tetrafluoroborate, tetramethylammonium hexafluorophosphonate, tetramethylammonium hexafluoroarsenate, tetramethylammonium trifluoromethane sulfonate, tetramethylammonium trifluoroacetate, tetramethylammonium-p-toluene sulfonate, tetramethylammonium butyltris(2,6-difluorophenyl)borate, tetramethylammonium hexyltris(p-chlorophenyl)borate, tetramethylammonium hexyltris(3-trifluoromethylphenyl)borate, tetrabutylammonium tetrafluoroborate, tetrabutylammonium hexafluorophosphonate, tetrabutylammonium hexafluoroarsenate, tetrabutylammonium trifluoromethane sulfonate, tetrabutylammonium trifluoroacetate, tetrabutylammonium-p-toluene sulfonate, tetrabutylammonium butyltris(2,6-difluorophenyl)borate, tetrabutylammonium hexyltris(p-chlorophenyl)borate, tetrabutylammonium hexyltris(3-trifluoromethylphenyl)borate, benzyltrimethylammonium tetrafluoroborate, benzyltrimethylammonium hexafluorophosphonate, benzyltrimethylammonium hexafluoroarsenate, benzyltrimethylammonium trifluoromethane sulfonate, benzyltrimethylammonium trifluoroacetate, benzyltrimethylammonium-p-toluene sulfonate, benzyltrimethylammonium butyltris(2,6-difluorophenyl)borate, benzyltrimethylammonium hexyltris(p-chlorophenyl)borate, benzyltrimethylammonium hexyltris(3-trifluoromethylphenyl)borate, benzyldimethylphenylammonium tetrafluoroborate, benzyldimethylphenylammonium hexafluorophosphonate, benzyldimethylphenylammonium hexafluoroarsenate, benzyldimethylphenylammonium trifluoromethane sulfonate, benzyldimethylphenylammonium trifluoroacetate, benzyldimethylphenylammonium-p-toluene sulfonate, benzyldimethylphenylammonium butyltris(2,6-difluorophenyla)borate, benzyldimethylphenylammonium hexyltris(p-chlorophenyl)borate, benzyldimethylphenylammonium hexyltris(3-trifluoromethylphenyl)borate, N-cinnamylideneethylphenylammonium tetrafluoroborate, N-cinnamylideneethylphenylammonium hexafluorophosphonate, N-cinnamylideneethylphenylammonium hexafluoroarsenate, N-cinnamylideneethylphenylammonium trifluoromethane sulfonate, N-cinnamylideneethylphenylammonium trifluoroacetate, N-cinnamylideneethylphenylammonium-p-toluene sulfonate, N-cinnamylideneethylphenylammonium butyltris(2,6-difluorophenyl)borate, N-cinnamylideneethylphenylammonium hexyltris(p-chlorophenyl)borate and N-cinnamylideneethylphenylammonium hexyltris(3-trifluoromethylphenyl)borate.

Examples of the sulfonic acid esters include α-hydroxymethyl benzoin-p-toluenesulfonic acid ester, α-hydroxymethylbenzoin-trifluoromethanesulfonic acid ester, α-hydroxymethylbenzoin-methanesulfonic acid ester, pyrogallol-tri(p-toluenesulfonic acid)ester, pyrogallol-tri(trifluoromethanesulfonic acid) ester, pyrogallol-trimethanesulfonico acid ester, 2,4-dinitrobenzyl-p-toluenesulfonic acid ester, 2,4-dinitrobenzyl-trifluoromethanesulfonic acid ester, 2,4-dinitrobenzyl-methanesulfonic acid ester, 2,4-dinitrobenzyl-1,2-naphthoquinonediazido-5-sulfonic acid ester, 2,6-dinitrobenzyl-p-toluenesulfonic acid ester, 2,6-dinitrobenzyl-trifluoromethanesulfonic acid ester, 2,6-dinitrobenzyl-methanesulfonic acid ester, 2,6-dinitrobenzyl-1,2-naphthoquinonediazido-5-sulfonic acid ester, 2-nitrobenzyl-p-toluenesulfonic acid ester, 2-nitrobenzyl-trifluoromethanesulfonic acid ester, 2-nitrobenzyl-methanesulfonic acid ester, 2-nitrobenzyl-1,2-naphthoquinonediazido-5-sulfonic acid ester, 4-nitrobenzyl-p-toluenesulfonic acid ester, 4-nitrobenzyl-trifluoromethanesulfonic acid ester, 4-nitrobenzyl-methanesulfonic acid ester, 4-nitrobenzyl-1,2-naphthoquinonediazido-5-sulfonic acid ester, N-hydroxynaphthalimide-p-toluenesulfonic acid ester, N-hydroxynaphthalimide-trifluoromethanesulfonic acid ester, N-hydroxynaphthalimide-methanesulfonic acid ester, N-hydroxy-5-norbornene-2,3-dicarboxyimide-p-toluensulfonic acid ester, N-hydroxy-5-norbornene-2,3-dicarboxyimide-trifluoromethanesulfonic acid ester, N-hydroxy-5-norbornene-2,3-dicarboxyimide-methanesulfonic acid ester, 2,4,6,3′,4′,5′-hexahydroxybenzophenone-1,2-naphthoquinonediazido-4-sulfonic acid ester and 1,1,1-tri(p-hydroxyphenyl)ethane-1,2-naphthoquinonediazido-4-sulfonic acid ester.

Among these compounds, 2-(3-chlorophenyl)-4,6-bis(trichloromethyl)-s-triazine, 2-(4-methoxyphenyl)-4,6-bis(trichloromethyl)-s-triazine, 2-(4-methylthiophenyl)-4,6-bis(trichloromethyl)-s-triazine, 2-(4-methoxy-β-styryl)-4,6-bis(trichloromethyl)-s-triazine, 2-piperonyl-4,6-bis(trichloromethyl)-s-triazine, 2-[2-(furan-2-yl)ethenyl]-4,6-bis(trichloromethyl)-s-triazine, 2-[2-(5-methylfuran-2-yl)ethenyl]-4,6-bis(trichloromethyl)-s-triazine, 2-[2-(4-diethylamino-2-methylphenyl)ethenyl]-4,6-bis(trichloromethyl)-s-triazine, and 2-(4-methoxynaphthyl)-4,6-bis(trichloromethyl)-s-triazine are preferred as trichloromethyl-s-triazines; diphenyliodonium trifluoroacetate, diphenyliodonium trifluoromethane sulfonate, 4-methoxyphenylphenyliodonium trifluoromethane sulfonate and 4-methoxyphenylphenyliodonium trifluoroacetate are preferred as diaryliodonium salts; triphenylsulfonium trifluoromethane sulfonate, triphenylsulfonium trifluoroacetate, 4-methoxyphenyldiphenylsulfonium trifluoromethane sulfonate, 4-methoxyphenyldiphenylsulfonium trifluoroacetate, 4-phenylthiophenyldiphenylsulfonium trifluoromethane sulfonate and 4-phenylthiophenyldiphenylsulfonium trifluoroacetate are preferred as triarylsulfonium salts; tetramethylammonium butyltris(2,6-difluorophenyl)borate, tetramethylammonium hexyltris(p-chlorophenyl)borate, tetramethylammonium hexyltris(3-trifluoromethylphenyl)borate, benzyldimethylphenylammonium butyltris(2,6-difluorophenyl)borate, benzyldimethylphenylammonium hexyltris(p-chlorophenyl)borate and benzyldimethylphenylammonium hexyltris(3-trifluoromethylphenyl)borate are preferred as quaternary ammonium salts; and 2,6-dinitrobenzyl-p-toluenesulfonic acid ester, 2,6-dinitrobenzyl-trifluoromethanesulfonic acid ester, N-hydroxynaphthalimide-p-toluenesulfonic acid ester and N-hydroxynaphthalimide-trifluoromethanesulfonic acid ester are preferred as sulfonic acid esters.

Examples of the photoradical polymerization initiator include organic halide compounds, carbonyl compounds, organic peroxide compounds, azo-based polymerization initiators, azide compounds, metalocene compounds, hexaaryl biimidazole compounds, organic boric acid compounds, disulfonic acid compounds, oxime ester compounds, and onium salt compounds.

Specific examples of the organic halide compounds include compounds disclosed in Wakabayashi, et al, “Bull Chem. Soc Japan”, 42, 2924 (1969), U.S. Pat. No. 3,905,815, JP-B No. 464605, JP-A Nos. 48-36281, 55-32070, 60-239736, 61-169835, 61-169837, 62-58241, 62-212401, 63-70243, and 63-298339, and M. P. Hutt, “Journal of Heterocyclic Chemistry”, 1 (No. 3), 1970. Among these compounds, oxazole compounds and S-triazine compounds substituted by a trihalomethyl group are particularly preferred.

More suitable are s-triazine derivatives comprising at least one mono, di or tri-halogen-substituted methyl group bonded to s-triazine ring. Specific examples thereof include 2,4,6-tris(monochloromethyl)-s-triazine, 2,4,6-tris(dichloromethyl)-s-triazine, 2,4,6-tris(trichloromethyl)-s-triazine, 2-methyl-4,6-bis(trichloromethyl)-s-triazine, 2-n-propyl-4,6-bis(trichloromethyl)-s-triazine, 2-(α,α,β-trichoroethyl)-4,6-bis(trichloromethyl)-s-triazine, 2-phenyl-4,6-bis(trichloromethyl)-s-triazine, 2-(p-methoxyphenyl)-4,6-bis(trichloromethyl)-s-triazine, 2-(3,4-epoxyphenyl)-4,6-bis(trichloromethyl)-s-triazine, 2-(p-chlorophenyl)-4,6-bis(trichloromethyl)-s-triazine, 2-[1-(p-methoxyphenyl)-2,4-butadienyl]-4,6-bis(trichloromethyl)-s-triazine, 2-styryl-4,6-bis(trichloromethyl)-s-triazine, 2-(p-methoxystyryl)-4,6-bis(trichloromethyl)-s-triazine, 2-(pi-propyloxystyryl)-4,6-bis(trichloromethyl)-s-triazine, 2-(p-tollyl)-4,6-bis(trichloromethyl)-s-triazine, 2-(4-natoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine, and 2-methoxy-4,6-bis(tribromomethyl)-s-triazine.

Examples of the carbonyl compound include benzophenone derivatives such as benzophenone, Michler's ketone, 2-methylbenzophenone, 3-methyl benzophenone, 4-methylbenzophenone, 2-chloro benzophenone, 4-bromobenzophenone and 2-carboxybenzophenone; acetophenone derivatives such as 2,2-dimethoxy-2-phenylacetophenone, 2,2-diethoxy acetophenone, 1-hydroxycyclohexylphenylketone, α-hydroxy-2-methylphenylpropanone, 1-hydroxy-1-methylethyl-(p-isopropylphenyl)ketone, 1-hydroxy-1-(p-dodecyl phenyl)ketone, 2-methyl-(4′-(methylthio)phenyl)-2-morpholino-1-propanone and 1,1,1-trichloromethyl-(p-butylphenyl)ketone; thioxanthone derivatives such as thioxanthone, 2-ethylthioxanthone, 2-isopropyl thioxanthone, 2-chlorothioxanthone, 2,4-dimethyl thioxanthone, 2,4-diethylthioxanthone and 2,4-diisopropylthioxanthone; and benzoic acid ester derivatives such as p-dimethylaminobenzoic acid ethyl and p-diethylaminobenzoic acid ethyl.

As the azo compound, azo compounds disclosed in JP-A No. 8-108621 may be used for example.

Examples of the organic peroxide compound include trimethylcyclohexanone peroxide, acetylacetone peroxide, 1,1-bis(tert-butylperoxy)-3,3,5-trimethyl cyclohexane, 1,1-bis(tert-butylperoxy)cyclohexane, 2,2-bis(tert-butylperoxy)butane, tert-butyl hydroperoxide, cumene hydroperoxide, diisopropyl benzene hydroperoxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)hexane, 2,5-oxanoyl peroxide, succinic acid peroxide, benzoyl peroxide, 2,4-dichlorobenzoyl peroxide, diisopropyl peroxydicarbonate, di-2-ethylhexyl peroxydicarbonate, di-2-ethoxyethyl peroxydicarbonate, dimethoxyisopropyl peroxycarbonate, di(3-methyl-3-methoxybutyl)peroxydicarbonate, tert-butylperoxy acetate, tert-butylperoxy pivalate, tert-butyl peroxy neodecanoate, tert-butylperoxy octanoate, tert-butylperoxy laurate, tertiary carbonate, 3,3′,4,4′-tetra-(t-butylperoxycarbonyl)benzophenone, 3,3′,4,4′-tetra-(t-hexylperoxycarbonyl)benzophenone, 3,3′,4,4′-tetra-(p-isopropylcumylperoxycarbonyl)benzophenone, carbonyldi(t-butylperoxy dihydrogen diphthalate), and carbonyldi(t-hexylperoxy dihydrogen diphthalate).

Examples of the metalocene compound include various titanocene compounds disclosed in JP-A Nos. 59-152396, 61-151197, 63-41484, 2-249, 2-4705 and 5-83588, for example, di-cyclopentadienyl-Ti-bis-phenyl, di-cyclopentadienyl-Ti-bis-2,6-difluoropheny-1-yl, di-cyclopentadienyl-Ti-bis-2,4-di-fluoropheny-1-yl, di-cyclopentadienyl-Ti-bis-2,4,6-trifluoropheny-1-yl, di-cyclopentadienyl-Ti-bis-2,3,5,6-tetrafluoropheny-1-yl, di-cyclopentadienyl-Ti-bis-2,3,4,5,6-pentafluoropheny-1-yl, di-methylcyclopentadienyl-Ti-bis-2,6-difluoropheny-1-yl, di-methylcyclo pentadienyl-Ti-bis-2,4,6-trifluoropheny-1-yl, di-methylcyclopentadienyl-Ti-bis-2,3,5,6-tetrafluoropheny-1-yl, di-methylcyclopentadienyl-Ti-bis-2,3,4,5,6-pentafluoropheny-1-yl, and iron-allene complex disclosed in JP-A Nos. 1-304453 and 1-152109.

Examples of the hexaaryl biimidazole compound include various compounds disclosed in JP-B No. 6-29285, U.S. Pat. Nos. 3,479,185, 4,311,783 and 4,622,286, specifically, 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(osp-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole, and 2,2′-bis(o-trifluorophenyl)-4,4′,5,5′-tetraphenylbiimidazole.

Specific examples of the organic borate compound include organic boric acid salts as disclosed in JP-A Nos. 62-143044, 62-150242, 9-188685, 9-188686, 9-188710, 2000-131837, and 2002-107916, JP-B No. 2764769, and Kunz, Martin, “Rad Tech'98. Proceeding April 19-22”, 1998, Chicago, organic boron-sulfonium complexes or organic boron-oxosulfonium complexes as disclosed in JP-A Nos. 6-157623, 6-175564 and 6-175561, organic boron-iodonium complexes as disclosed in JP-A Nos. 6-175554 and 6-175553, organic boron-phosphonium complexes as disclosed in IP-A No. 9-188710, and organic boron-transition metal coordinated complexes as disclosed in JP-A Nos. 6-348011, 7-128785, 7-140589, 7-306527 and 7-292014.

Examples of the disulfone compound include compounds as disclosed in JP-A Nos. 61-166544 and 2003-328465.

Examples of the oxime ester compound include compounds as disclosed in J. C. S. Perkin II (1979) 1653-1660, J. C. S. Perkin II (1979) 156-162, Journal of Photopolymer Science and Technology (1995) 202-232, JP-A Nos. 2000-66385 and 2000-80068, specifically, compounds shown below.

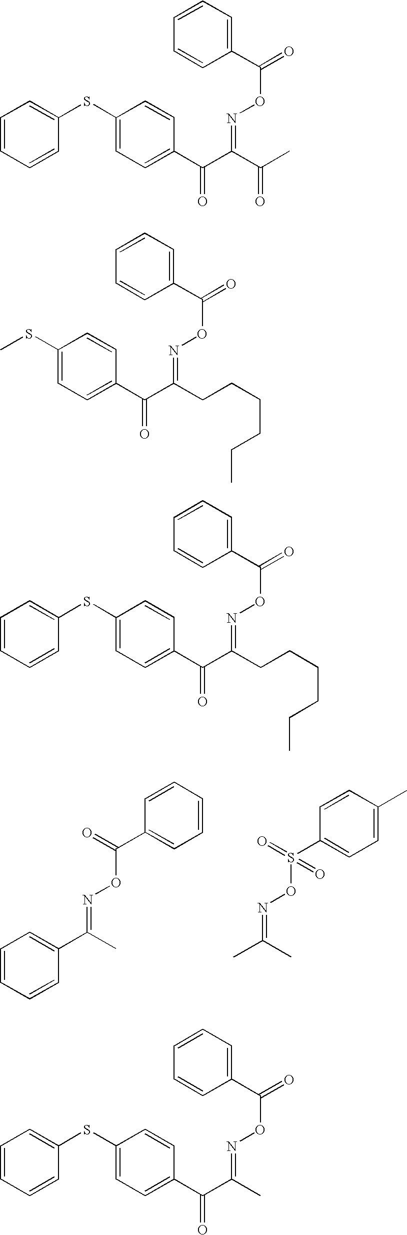

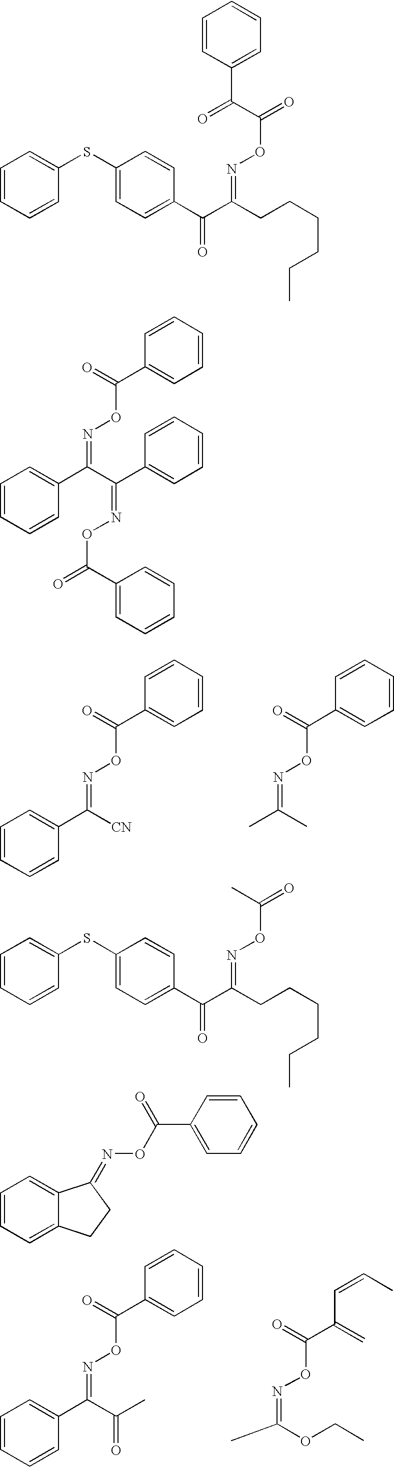

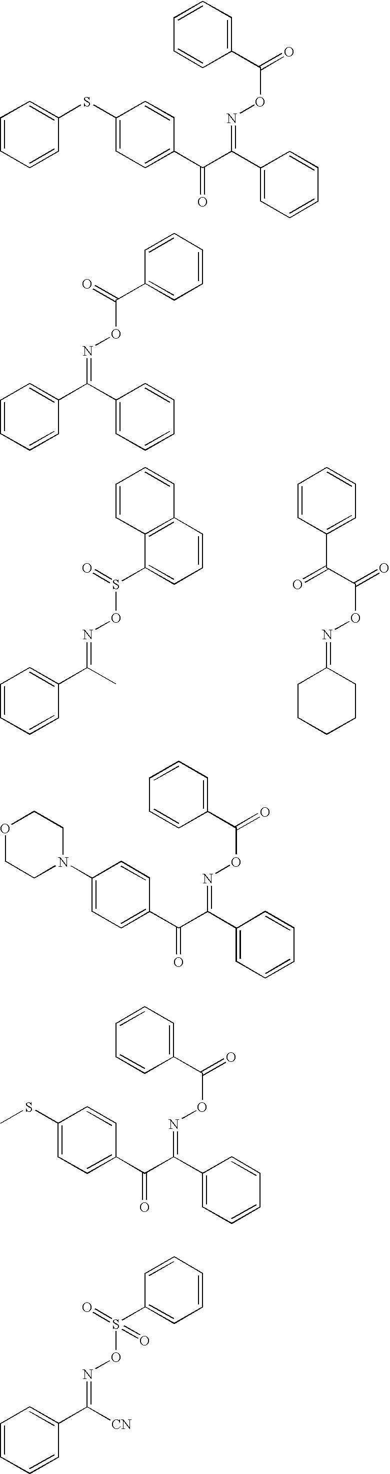

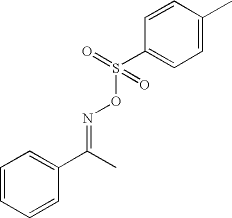

Examples of the onium salt compound include compounds described above as a cationic polymerization initiator, further include diazonium salts as disclosed in S. I. Schlesinger, “Photogr. Sci. Eng.”, 18, 387 (1974) and T. S. Bal et al, “Polymer”, 21, 423 (1980), ammonium salts as disclosed in U.S. Pat. No. 4,069,055 and JP-A No. 4-365049, phosphonium salts as disclosed in U.S. Pat. Nos. 4,069,055 and 4,069,056, iodonium salts as disclosed in European Patent No. 104,143, U.S. Pat. Nos. 339,049 and 410,201, JP-A Nos. 2-150848, and 2-296514, sulfonium salts as disclosed in European Patent Nos. 370,693, 390, 214, 233, 567, 297,443 and 297,442, U.S. Pat. Nos. 4,933,377, 161,811, 410,201, 339,049, 4,760,013, 4,734,444 and 2,833,827, and German Patent Nos. 2,904,626,3,604,580 and 3,604,581, selenonium salts as disclosed in J. V. Crivello et al, “Macromolecules”, 10 (6), 1307 (1977) and J. V. Crivello et al, “J. Polymer Sci., Polymer Chem. Ed.”, 17, 1047 (1979), and arsonium salts as disclosed in C. S. Wen et al, “Teh, Proc. Conf. Rad. Curing ASIA”, page 478, Tokyo, October 1988.

Among these compounds, oxime ester compounds or diazonium salts, iodonium salts, and sulfonium salts are most preferred in terms of reactivity and stability. In the invention, these onium salts act as a cationic polymerization initiator, and also act as an inonic radical polymerization initiator. This property enables a single compound to activate both cationic polymerization and radical polymerization.

In order to further sensitize the photopolymerization initiator, a sensitizer may further be added. Examples of such sensitizer include coumarins having a substituent at least one of at the 3-position and at the 7-position, flavones, dibenzalacetones, dibenzalcyclohexanes, chalcones, xanthenes, thioxanthenes, porphyrins, phthalocyanines, acridines and anthracenes.

When an unsaturated carboxylic ester and/or unsaturated carboxylic amide are used as the polymerizable monomer, a photosensitive radical polymerization initiator is suitably employed. When a vinyl ether compound and/or vinyl ester compound are used, a photosensitive cationic polymerization initiator is suitably employed. When a styrene compound is used as the polymerizable monomer, both a photosensitive radical polymerization initiator and a photosensitive cationic polymerization initiator can be employed.

The content of the photopolymerization initiator is preferably in the range of 0.1% by mass to 10% by mass, more preferably in the range of 1% by mass to 7% by mass, most preferably in the range of 1.5% by mass to 5% by mass of the total solid components of the composition for optical recording. Within this range, it is possible to obtain the highest sensitivity.

The light application unit for use in the photopolymerization is not particularly limited and can be appropriately selected depending on the intended purpose. For applications in optical recording, light beams of 405 nm and 532 nm, or light beams with wavelengths closer to the ultraviolet region, especially, laser beams are suitably used. A laser beam is coherent and is capable of writing finer patterns as interference fringes than the actual width of beam, thus most preferable as a light source. The irradiation energy of the light application unit is preferably from 0.001 mJ/cm² to 200 mJ/cm², more preferably from 0.01 mJ/cm² to 100 mJ/cm², most preferably from 0.5 mJ/cm² to 50 mJ/cm². In order to promote the photopolymerization, light also may be applied under the condition of heating by any means.

Moreover, a sensitizing dye that matches to the wavelength of light applied may be used as a sensitizer in combination.

The sensitizer is not particularly limited and can be appropriately selected depending on the intended purpose. Examples thereof include merocyanine dyes, cyanine dyes, squarylium dyes, dibenzylacetone dyes, xanthene dyes, triphenyl methane dyes, acridine dyes, and derivatives of thioxanthone, anthracene, phenanthrene, pyrene, acridine, carbazole, or phenothiazine. Among these, xanthene dyes, and derivatives of thioxanthone, anthracene, carbazole, or phenothiazine are preferable. These may be used singly or in combination. The content of the sensitizer is preferably 0.05% by mass to 0.1% by mass, more preferably 0.1% by mass to 5% by mass of the total solid components of the composition for optical recording.

<Other Compound>

The other compound is not particularly limited and can be appropriately selected depending on the intended purpose. For example, a polymerization inhibitor of photopolymer, antioxidant, and the like may be added in order to improve shelf life.

The polymerization inhibitor and antioxidant is not particularly limited and can be appropriately selected depending on the intended purpose; examples thereof include hydroquinones, p-benzoquinone, hydroquinone monoethylether, 2,6-di-t-butyl-p-cresol, 2,2′-methylenebis(4-methyl-6-t-butylphenol), triphenyl phosphite, trisnonylphenyl phosphite, phenothiazine, and N-isopropyl-N′-phenyl-p-phenylenediamine. Among these, triphenyl phosphate and phenothiazine are preferable. These may be used singly or in combination.

The amount of the polymerization inhibitor and antioxidant to be added is 3% by mass or less of the total polymerizable monomers to be used in the composition; if it exceeds 3% by mass, the rate of polymerization reactions may be reduced, or polymerization reactions may not take place in some cases.

(Optical Recording Medium)

The optical recording medium of the invention is an optical recording medium which comprises a support, a recording layer of the invention for recording information utilizing holography on the support, and may further comprise an additional layer on an as-needed basis.

The optical recording medium of the invention may adopt a relatively thin, flat hologram for recording two-dimensional information or may adopt a volume hologram for recording much three-dimensional information such as stereoimages, and in either case, the hologram may be any of transmissive type and reflective type. In addition, the hologram may be recorded in any method, including amplitude holograms, phase holograms, blazed holograms, complex amplitude holograms and so forth.

The optical recording medium of the invention is recorded and/or reproduced by any method and/or any apparatus without limitation and the method and/or apparatus can be selected depending on the intended purpose. Examples thereof include optical recording methods and optical recording apparatuses disclosed in U.S. Pat. Nos. 5,719,691, 5,838,467, 6,163,391, and 6,414,296, U.S. Patent Application No. 2002-136143, JP-A Nos. 2000-98862, 2000-298837, 2001-23169, 2002-83431, 2002-123949, 2002-123948, 2003-43904, and 2004-171611, and International Publication Nos. WO 99/57719, WO 02/05270, and WO 02/75727.

For example, the optical recording medium of the invention adopts the following two forms: The first includes at least one support on which a recording layer is deposited. This form is used for general holographic recording in which information light and reference light are applied from different directions. The second form is used for the collinear technology, where the information light and reference light are applied in such a way that the optical axis of the information light is collinear with that of the reference light. The second includes a first substrate, a second substrate, a recording layer provided on the second substrate, a filter layer provided between the second substrate and the recording layer and additional layers provided on an as-needed basis. The first and second forms will be described below.

<<First Form>>

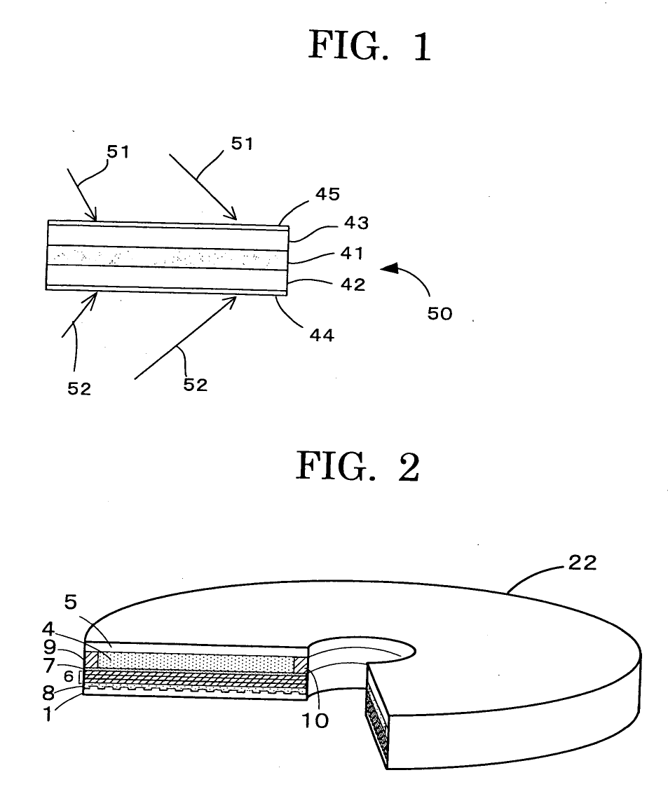

The first form is used for general holographic recording; its layer structure is not particularly limited and can be appropriately determined depending on the intended purpose. For example, the following layer structures can be contemplated: a structure in which single or multiple recording layers are provided on a support; and a structure as shown in FIG. 1, in which a recording layer 41 is interposed between supports 42 and 43, and antireflection layers 44 and 45 are formed on the outermost layers of the support 42 and 43, respectively.

Furthermore, a gas barrier layer or the like may be provided between the recording layer 41 and the support 42 and/or between the recording layer 41 and the support 43. A protection layer may also be provided on the surfaces of the antireflection layers 44 and 45.

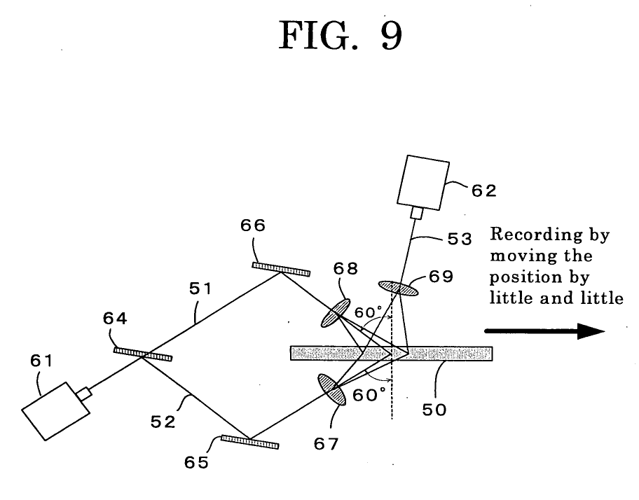

The optical recording method according to the first form records information in the following manner: As shown in FIG. 9, the light from a light source 61 is split into two rays, one forming information light 51 that passed through a half mirror 64, and one forming a reference light 52 reflected by the half mirror 64. The information light 51 is expanded through a mirror 66 and a beam expander 68, and is shined on the recording layer of an optical recording medium 50. The reference light 52 is expanded through a mirror 65 and a beam expander 67, and is shined on the opposite side of the recording layer. In this way the information light 51 and reference light 52 create an interference fringe, which is recorded on the recording layer as optical information.

As shown in FIG. 9, a fixing light 53 is emitted from a second light source 62, is expanded through a beam expander 69, and is applied onto the recorded interference image.

Using this recording method, recording is repeated by moving the optical recording medium 50 by little and little as shown in FIG. 9, enabling multiplexing recording in the optical recording medium 50.

<Information Light and Reference Light>

The information light and reference light are not particularly limited and can be appropriately selected depending on the intended purpose. For example, a coherent laser beam emitted from a light source is preferably used.

The laser beam is not particularly limited, and laser beams that have the capability to emit one or more wavelengths of 360 nm to 850 nm are suitably used. The wavelength is preferably 380 nm to 800 nm, more preferably 400 nm to 750 nm, most preferably 500 nm to 600 nm where the center of the visual region is most visible.

If the wavelength is less than 360 nm, it sometimes results in failure to obtain a sharp three-dimensional image, whereas if the wavelength exceeds 850 nm, the interference image has a fine optical fringe pattern, and a photosensitive material that can be adaptable to that interference image may not be obtained.

The light source of the laser beam is not particularly limited and can be appropriately selected depending on the intended purpose. For example, a solid-state laser oscillator, semiconductor laser oscillator of blue region, liquid-state laser oscillator, or gas-state laser oscillator such as argon, He—Cd laser oscillator, frequency-doubled YAG laser oscillator, He—Ne laser oscillator, Kr laser oscillator can be used. Among these, a gas-state laser oscillator or semiconductor laser oscillator of blue region can be suitably used.

The method for applying the information light and reference light is not particularly limited and can be appropriately selected depending on the intended purpose. For example, a laser beam from one light source may be split into the information light and reference light. Alternatively two laser beams emitted from different light sources may be used as the information light and reference light.

The direction in which the information light and reference light are applied is not particularly limited and can be appropriately determined depending on the intended purpose. For example, the information light and reference light may be applied from different directions, or may be applied from the same direction. Alternatively, they may be applied in such a way that the optical axis of the information light is collinear with that of the reference light.

<Fixing Light>

The light source 61 which emits the information light and reference light may be used as the fixing light. Alternatively, as shown in FIG. 9, using a different light source 62, the fixing light 53 emitted from the light source 62 may be applied on a recording region through a beam expander 69. The region on which the fixing light is applied is not particularly limited and can be appropriately determined depending on the intended purpose. For example, the fixing light may be applied on almost the same region where the information light and reference light are applied for the recording of information. Alternatively, the fixing light may be applied on that region, including a region within 1 μm of the periphery thereof. If the fixing light is applied to regions other than this region (i.e., beyond 1 μm of the periphery of the recording region), adjacent recording regions are also irradiated with the fixing light, leading to inefficient recording due to this excess irradiation.

The length of time that the fixing light is applied is not particularly limited and can be appropriately determined depending on the intended purpose; it is preferably 1 ns to 100 ms, more preferably 1 ns to 80 ms at a given position of the recording layer. If this irradiation time is less than 1 ns, it sometimes result in insufficient fixing of recorded information, whereas if it exceeds 100 ms, it results in excessive irradiation.

The direction in which the fixing light is applied is not particularly limited and can be appropriately determined depending on the intended purpose. For example, the direction in which the fixing light is applied may be the same as the direction in which the information light and reference light are applied, or may be different. In addition, the irradiation angle (measured from the normal of the recording layer) is preferably 0° to 60°, more preferably 0° to 40°. If the irradiation angle is outside of this range, it may result in inefficient fixing operations.

The wavelength of the fixing light is not particularly limited and can be appropriately determined depending on the intended purpose. For example, the fixing light preferably has a wavelength of 350 nm to 850 nm, more preferably 400 nm to 600 nm at a given position of the recording layer.

If the wavelength of the fixing light is less than 350 nm, the material constituting the recording layer may decompose, whereas if the wavelength exceeds 850 nm, the material may be degraded owing to increased temperature.

The light source of the fixing light is not particularly limited and can be appropriately selected depending on the intended purpose. For example, incoherent beams are preferable; fluorescent light, high-pressure mercury vapor lamps, xenon lamps, light emitting diodes, and beams obtained by randomly altering the phase of coherent beams by, for example, providing frosted glass on their optical path are used. Among these, light emitting diodes, the beams obtained by randomly altering the phase of coherent beams are preferable.

The dose of the fixing light to be applied is not particularly limited and can be appropriately determined depending on the intended purpose. For example, it is preferably 0.001 J/cm² to 1 J/cm², more preferably 0.01 J/cm² to 300 J/cm² at a given position of the recording layer.

The method for applying the fixing light is not particularly limited and can be appropriately selected depending on the intended purpose. For example, light from the light source that emits the information light and reference light at a given position of the recording layer may be applied as the fixing light. Alternatively, two rays of light emitted from different light sources may be used as the fixing light.

<Recording Layer>

The recording layer comprises the composition for optical recording of the invention and may further comprise other components appropriately selected according to necessity.

The recording layer is formed by applying or injecting using a method known in the art, followed by a process of heat curing. As the method for applying, an ink-jet method, spin coating method, kneader coating method, bar coating method, blade coating method, dip coating method, curtain coating method, casting method, screen printing method, and the like are known in the art and applicable. The injecting method known in the art are: (1) a method in which a partition is provided on a desired substrate, a certain amount of composition for optical recording is poured therein using a method such as a dispenser, screen printing and casting, sealed with an upper substrate, and then heat cured; (2) a method in which beforehand, a plurality of substrates are bonded with partition materials interposed, or held with an external holding tool such that an air space is provided between substrates at a given interval, and then a solution of composition for optical recording is injected into the air space using, for example, a dispenser, immediately followed by heat curing.

The thickness of the recording layer is not particularly limited and can be appropriately set depending on the intended purpose, preferably 1 μm to 1,000 μm, more preferably 100 μm to 800 μm, most preferably 200 μm to 700 μm. In particular, if the recording layer having the thickness within the above-mentioned range is used for volume holograms, not only excellent S/N ratios are achieved, but also a medium suitable for multiplexing recording is provided. Further, in the more preferable thickness range mentioned above, excellent S/N ratios and signal intensity can be maintained even when 10- to 300-time multiplexing recording operation is performed.

—Support—

The shape, structure, size and the like of the support are not particularly limited and can be appropriately set depending on the intended purpose; examples of the shape of the support include a disc shape, card-like flat shape, and sheet shape; examples of the structure of the support include a single-layer structure and multilayered structure; and the size of the support can be appropriately set according to the size of the optical recording medium, for example.

The material for the support is not particularly limited, and inorganic and organic materials can be suitably used. However, organic and inorganic materials that can ensure mechanical strength of optical recording media are required. In addition, when the support is transparent enough to admit recording light and reproduction light, organic and inorganic materials that can admit these recording light and reproduction light are required.

Examples of the inorganic materials include glass, quartz and silicon.

Examples of the organic materials include acetate resins such as triacetylcellulose, polyester resins, polyethersulfone resins, polysulfone resins, polycarbonate resins, polyamide resins, polyimide resins, polyolefin resins, acrylic resins, polynorbornene resins, cellulose resins, polyarylate resins, polystyrene resins, polyvinylalcohol resins, polyvinyl chloride resins, polyvinylidene chloride resins, polyacrylic resins, polylactate resins, plastic film laminate paper and synthetic paper. These may be used singly or in combination. Among these, polycarbonate resins and acrylic resins are preferable in light of their formability, optical characteristics, and costs.

The support may be either a freshly prepared one or a commercially available one.

The thickness of the support is not particularly limited and can be appropriately set depending on the intended purpose; the thickness is preferably 0.1 mm to 5 mm, more preferably 0.3 mm to 2 mm. If the thickness of the support is less than 0.1 mm, the optical information disc containing the support may become deformed. If the thickness is greater than 5 mm, the weight of the optical information disc is increased, so too does the load on a drive motor that spins it.

<<Second Form>>

The second form of the optical recording medium is intended for the collinear technology, where information light and reference light are applied in such a way that the optical axis of the information light is collinear with that of the reference light. Examples of the second form include an optical recording medium that includes a first substrate, a second substrate, the recording layer of the invention on the second substrate, and a dichroic mirror layer provided between the second substrate and the recording layer, and an optical recording medium in which a filter layer is disposed in place of the above-mentioned dichroic mirror layer.

<Optical Recording Method and Reproducing Method in the Second Form>

The optical recording method in the second form uses the so-called collinear technology, where information light and reference light are applied in such a way that the optical axis of the information light is collinear with that of the reference light, and optical interference between the information light and reference light creates an interference pattern, or information, to be recorded on a recording layer.

As in the case of the foregoing first form, the collinear technology applies information light and reference light onto at least a part of the recording layer in the optical recording medium. In this way, optical recording that offers high definition and excellent diffraction efficiency can be obtained.

The reproducing method is not particularly limited and can be appropriately selected depending on the intended purpose. For example, the recorded information can be reproduced by applying another reference light onto the interference images recorded on the recording layer using the optical recording method.

In the optical recording method and reproducing method in the second form, information light with a two-dimensional intensity distribution and a reference light with an intensity level equal to that of the information light are superimposed inside a photosensitive recording layer to form an interference pattern, and an optical characteristic distribution is created by means of the interference pattern, whereby information is recorded in the recording layer. Meanwhile, upon reading (reproducing) of the written information, only a reference light is applied onto the recording layer from the same direction, and thereby a reproduction light is emitted from the recording layer as a light that has an intensity distribution corresponding to the optical characteristic distribution formed in the recording layer.

Here, the optical recording method and reproducing method in the second form is used in an optical recording and reproducing apparatus described below.

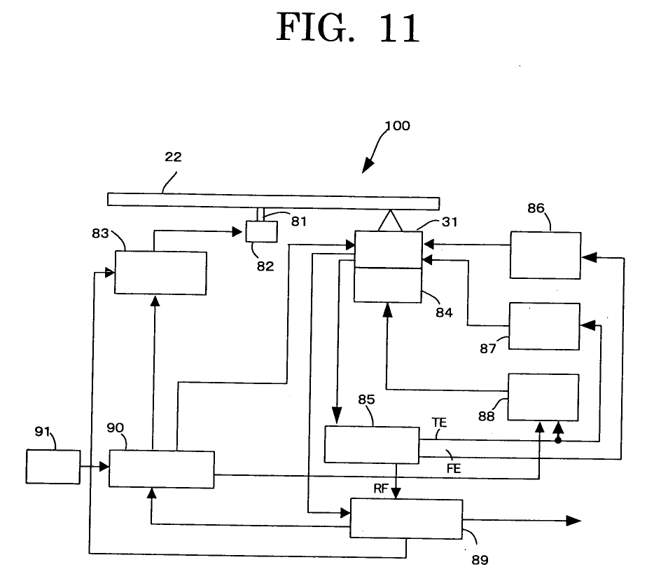

The optical recording and reproducing apparatus used for the optical recording method and reproducing method will be described with reference to FIG. 11. FIG. 11 is a block diagram showing an example of the entire configuration of an optical recording and reproducing apparatus according to the second form. Note that this apparatus includes an optical recording apparatus and a reproducing apparatus.

The optical recording and reproducing apparatus 100 includes a spindle 81 to which an optical recording medium 22 is attached, a spindle motor 82 for spinning the spindle 81, and a spindle servo circuit 83 for controlling the spindle motor 82 so that the rotation speed of the optical recording medium 22 is constant at a predetermined level.

In addition, the optical recording and reproducing apparatus 100 includes a pickup 31 which applies information light and recording reference light onto the optical recording medium 22, fixes the exposed region, and applies a reproduction reference light onto the optical recording medium 22 to detect a reproduction light for the reproduction of information recorded in the optical recording medium 22, and a drive device 84 that enables the pickup 31 to move in the radial direction of the optical recording medium 22.

The optical recording and reproducing apparatus 100 includes a detection circuit 85 for detecting a focus error signal FE, a tracking error signal TE and a reproduction signal RF from the output signal of the pickup 31, a focus servo circuit 86 for performing a focus servo operation by driving an actuator inside the pickup 31 on the basis of the focus error signal FE detected by the detection circuit 85 to move an objective lens (not shown) in the thickness direction of the optical recording medium 22, a tracking servo circuit 87 for performing a tracking servo operation by driving an actuator inside the pickup 31 on the basis of the tracking error signal TE detected by the detection circuit 85 to move the objective lens in the radial direction of the optical recording medium 22, and a slide servo circuit 88 for performing a slide servo operation by controlling the drive device 84 on the basis of a tracking error signal TE and commands from a controller to be described later to move the pickup 31 in the radial direction of the optical recording medium 22.

Furthermore, the optical recording and reproducing apparatus 100 includes a signal processing circuit 89 which decodes output data from a CMOS or CCD array to be described later in the pickup 31 to reproduce data recorded on the data area of the optical recording medium 22; which creates a reference clock on the basis of a reproduction signal RF detected by the detection circuit 85; and which distinguishes individual addresses, a controller 90 for controlling overall of the optical recording and reproducing apparatus 100, and a operation unit 91 for giving a variety of commands to the controller 90.

The controller 90 receives the reference clock and address information outputted from the signal processing circuit 89 and controls, for example, the pickup 31, spindle servo circuit 83 and slide servo circuit 88. The spindle servo circuit 83 receives the reference clock outputted from the signal processing circuit 89. The controller 90 includes a CPU (central processing unit), ROM (read only memory) and RAM (random access memory), and the CPU realizes the function of the controller 90 by executing programs stored in the ROM on the RAM, a working area.

<Recording Layer>

A recording layer similar to that used for the first form can be used.

<Filter Layer>

The filter layer has a function to reflect light with a selected wavelength, i.e., reflects only light with a specific wavelength out among rays of light with various wavelengths. Particularly, the filter layer serves to eliminate the occurrence fluctuations in the wavelengths selected to be reflected in a case where the incident angle is changed, and has a function to prevent irregular reflection of the information light and reference light at the reflective film of an optical recording medium to thereby prevent the occurrence of noise. Providing such a filter layer on the optical recording medium will lead to high definition and excellent diffraction efficiency.

The filter layer is not particularly limited and can be appropriately selected depending on the intended purpose. For example, the filter layer is comprised of a dichroic mirror layer and a colored material-containing layer, and comprised of at least one of a dielectric material-deposited layer, a single-layered or multilayered cholesteric liquid crystal layer, and additional layers provided on an as-needed basis.

The filter layer may be directly applied and deposited onto the support together with the recording layer. Alternatively, the filter layer may be previously deposited on a base material such as a film to prepare a filter for optical recording media, and the filter may be deposited on the support.

—Dichroic Mirror Layer—

In order for the dichroic mirror layer to serve as a reflective film through which light of desired wavelength passes, multiple dichroic mirror layers are preferably laminated. The number of the dichroic mirror layers to be laminated is preferably 1 to 50, more preferably 2 to 40, most preferably 2 to 30. If the number of the dichroic mirror layers to be laminated is greater than 50, it results in the reduction in productivity because of multilayer vapor deposition and results in the reduced change in the spectral transmission characteristics, bringing a smaller effect compared with the increased number of layers.

The dichroic mirror layers can be laminated by any method without limitation and the method can be appropriately selected depending on the intended purpose. For example, a vacuum vapor deposition process such as ion plating and ion beam, a physical vapor deposition (PVD) such as sputtering, and a chemical vapor deposition (CVD) can be used. Among these methods, a vacuum vapor deposition and sputtering are preferable, and sputtering is most preferable.

For the sputtering, DC sputtering is preferable because it offers high deposition rate. Note that highly conductive material is preferably used when DC sputtering is employed.

Examples of the method for depositing multiple dielectric thin layers by sputtering include: (1) a single-chamber method, where multiple dichroic mirror layers are alternately or sequentially deposited using a single chamber; and (2) a multi-chamber method, where multiple dichroic mirror layers are sequentially deposited using multiple chambers. In view of the productivity and to prevent contamination among materials, the multi-chamber method is most preferable.

The thickness of the dichroic mirror layer is preferably λ/16 to λ, more preferably λ/8 to 3λ/4, most preferably λ/6 to 3λ/8 in terms of optical wavelength.

—Colored Material-Containing Layer—

The colored material-containing layer is formed of a colored material, a binder resin, a solvent, and additional components provided on an as-needed basis.

Suitable examples of the colored material include pigments and dyes. Among these, red pigments and red dyes are preferable because they absorb light of wavelength 532 nm and admit a servo light of wavelength 655 nm or 780 nm; red pigments are most preferable.

The red dyes are not particularly limited and can be appropriately selected from those known in the art; examples thereof include acidic dyes such as C. I. Acid Reds 1, 8, 13, 14, 18, 26, 27, 35, 37, 42, 52, 82, 87, 89, 92, 97, 106, 111, 114, 115, 134, 186, 249, 254 and 289; basic dyes such as C. I. Basic Reds 2, 12, 13, 14, 15, 18, 22, 23, 24, 27, 29, 35, 36, 38, 39, 46, 49, 51, 52, 54, 59, 68, 69, 70, 73, 78, 82, 102, 104, 109 and 112; and reactive dyes such as C. I Reactive Reds 1, 14, 17, 25, 26, 32, 37, 44, 46, 55, 60, 66, 74, 79, 96 and 97. These dyes may be used singly or in combination.

The red pigments are not particularly limited and can be appropriately selected from those known in the art; examples thereof include C. I. Pigment Red 9, C. I. Pigment Red 97, C. I. Pigment Red 122, C. I. Pigment Red 123, C. I. Pigment Red 149, C. I. Pigment Red 168, C. I. Pigment Red 177, C. I. Pigment Red 180, C. I. Pigment Red 192, C. I. Pigment Red 209, C. I. Pigment Red 215, C. I. Pigment Red 216, C. I. Pigment Red 217, C. I. Pigment Red 220, C. I. Pigment Red 223, C. I. Pigment Red 224, C. I. Pigment Red 226, C. I. Pigment Red 227, C. I. Pigment Red 228, C. I. Pigment Red 240, C. I. Pigment Red 48:1, Permanent Carmine FBB (C. I. Pigment Red 146), Permanent Ruby FBH (C. I. Pigment Red 11) and Faster Pink B Supra (C. I. Pigment Red 81). These pigments may be used singly or in combination.

Among these red pigments, those with an optical transmittance of 10% or less for light of wavelength 532 nm and 90% or more for light of wavelength 655 nm are most preferably used.

The content of the colored material is preferably 0.05% by mass to 90% by mass, more preferably 0.1% by mass to 70% by mass of the total solid components of the colored material-containing layer. If the content of the colored material is less than 0.05% by mass, the thickness of the colored material-containing layer may need to be set to 500 μm or more. If the content of the colored material is greater than 90% by mass, the colored material-containing layer may collapse during its preparation due to lack of self-supporting properties.

—Binder Resin—

The binder resin is not particularly limited and can be appropriately selected from those known in the art; examples thereof include polyvinylalcohol resins; vinyl chloride/vinyl acetate copolymers; copolymers of vinyl chloride or vinyl alcohol and at least one of malleic acid and acrylic acid; vinyl chloride/vinylidene chloride copolymers; vinyl chloride/acrylonitrile copolymers; ethylene/vinyl acetate copolymers; celluloses derivatives such as nitrocellulose resins; polyacrylic resins; polyvinylacetal resins; polyvinylbutyral resins; epoxy resins; phenoxy resins; polyurethane resins; and polycarbonate resins. These materials can be used singly or in combination.

In addition, polar groups (e.g., epoxy group, CO₂H, OH, NH₂, SO₃M, OSO₃M, PO₃M2, and OPO₃M2, where M represents a hydrogen atom, alkali metal, or ammonium and if two or more M's appear, they may be different) are preferably introduced into the molecules of the above-listed binder resins in order to increase their dispersibility and durability. The content of such polar groups is preferably 10⁻⁶ to 10⁻⁴ equivalents per gram of binder resin.

The binder resins are preferably cured by the addition of a known isocyanate crosslinking agent.

The content of the binder resin is preferably 10% by mass to 99.5% by mass, more preferably 30% by mass to 99.9% by mass of the total solid components of the colored material-containing layer.

Each of these components described above is dissolved or dispersed in a suitable solvent to prepare a coating solution, and the coating solution is applied over a substrate to be described later using a desired coating method. In this way a colored material-containing layer can formed.

The solvent is not particularly limited and can be appropriately selected from those known in the art; examples thereof include water; alkoxypropionic acid esters such as 3-methoxypropionic acid methylester, 3-methoxypropionic acid ethylester, 3-methoxypropionic acid propylester, 3-ethoxypropionic acid methylester, 3-ethoxypropionic acid ethylester and 3-ethoxypropionic acid propylester; alkoxy alcohol esters such as 2-methoxypropylacetate, 2-ethoxypropylacetate and 3-methoxybutylacetate; lactic acid esters such as methyl lactate and ethyl lactate; ketones such as methyl ethyl ketone, cyclohexanone and methylcyclohexanone; γ-butyrolactone; N-methylpyrrolidone; dimethylsulfoxide; chloroform; and tetrahydrofuran. These solvents may be used singly or in combination.

The coating method is not particularly limited and can be appropriately selected depending on the intended use; examples thereof include an ink-jet method, spin coating method, kneader coating method, bar coating method, blade coating method, casting method, dipping method, and curtain coating method.

The thickness of the colored material-containing layer is preferably 0.5 μm to 200 μm, more preferably 1.0 μm to 100 μm, for example. If the thickness of the colored material-containing layer is less than 0.5 μm, binder resin that encapsulates colored material to form a film cannot be added in sufficient amounts in some cases. If the thickness of the colored material-containing layer is greater than 200 μm, the resultant filter is made too thick, thus requiring a big optical system for an irradiating light and servo light in some cases.

—Dielectric Material-Deposited Layer—

The dielectric material-deposited layer is formed on the colored material-containing layer, and is a laminate of multiple dielectric thin layers with different refraction indices. For the dielectric material-deposited layer to serve as a reflective film through which light of desired wavelength passes, it is preferably a laminate of alternating dielectric thin layers with high and low indices of refraction; however, three or more different dielectric thin layers may be laminated.

The number of the dielectric thin layers to be laminated is preferably 2 to 20, more preferably 2 to 12, still further preferably 4 to 10, most preferably 6 to 8. If the number of the dielectric thin layers to be laminated is greater than 20, it results in the reduction in productivity because of multilayer vapor deposition. The object and effect of the invention cannot be achieved in some cases.

The order in which the dielectric thin layers are laminated is not particularly limited, and can be appropriately determined depending on the intended purpose. A dielectric thin layer with low refractive index is first deposited in a case where an adjacent dielectric thin layer has high refractive index. On the other hand, a dielectric thin layer with high refractive index is first deposited in a case where an adjacent dielectric thin layer has low refractive index. The criteria of refractive index for determining whether a dielectric thin layer has high or low refractive index is preferably set to 1.8; note, however, that this determination is made on an arbitrary basis. That is, dielectric thin layers with different refractive indices equal to or greater than 1.8 (i.e., there are dielectric thin layers with high and low refractive indices) may be used to form such a laminate.

The material for the dielectric thin layer with high refractive index is not particularly limited and can be appropriately selected depending on the intended purpose; examples thereof include Sb₂O₃, Sb₂S₃, Bi₂O₃, CeO₂, CeF₃, HfO₂, La₂O₃, Nd₂O₃, Pr₆O₁₁, Sc₂O₃, SiO, Ta₂O₅, TiO₂, TlCl, Y₂O₃, ZnSe, ZnS and ZrO₂. Among these, Bi₂O₃, CeO₂, CeF₃, HfO₂, SiO, Ta₂O₅, TiO₂, Y₂O₃, ZnSe, ZnS and ZrO₂ are preferable, and SiO, Ta₂O₅, TiO₂, Y₂O₃, ZnSe, ZnS and ZrO₂ are more preferable.

The material for the dielectric thin layer with low refractive index is not particularly limited and can be appropriately selected depending on the intended purpose; examples thereof include Al₂O₃, BiF₃, CaF₂, LaF₃, PbCl, PbF₂, LiF, MgF₂, MgO, NdF₃, SiO₂, Si₂O₃, NaF, ThO₂ and ThF₄. Among these, Al₂O₃, BiF₃, CaF₂, MgF₂, MgO, SiO₂ and Si₂O₃ are preferable, and Al₂O₃, CaF₂, MgF₂, MgO, SiO₂ and Si₂O₃ are more preferable.

Note that the atomic ratio in the material for the dielectric thin layer is not particularly limited and can be appropriately set depending on the intended purpose. The atomic ratio can be adjusted by changing the concentration of atmosphere's gas upon deposition of dielectric thin layers.

The dielectric thin layers can be laminated by any method without limitation and the method can be appropriately selected depending on the intended purpose. For example, the dielectric thin layers can be laminated using the same method as that used to laminate the dichroic mirror layers.

The thickness of the dielectric thin layer is preferably λ/16 to λ, more preferably λ/8 to 3λ/4, most preferably λ/6 to 3λ/8 in terms of optical wavelength.

A part of light propagating through the dielectric material-deposited layer is reflected at each dielectric thin layer therein, and optical interference takes place among the reflected beams of the light. Thus, only light that has a wavelength determined on the basis of the product of the thickness of the dielectric thin layer and the refractive index of the layer for the light can pass through the dielectric material-deposited layer. In addition, the central wavelength of light to be admitted in the dielectric material-deposited layer is dependent on the angle at which light is incident thereto. The wavelength of light to be admitted can be changed by chaining the incident angle.

Since the number of dielectric thin layers deposited in the dielectric material-deposited layer is set to 20 or less, several percent to several tens of percent of selectively reflected light passes through the filter and enters the dielectric thin layer. However, the reflected light is absorbed by the colored material-containing layer provided immediately under the dielectric material-deposited layer. It should be noted that the colored material-containing layer contains red pigments and/or red dyes, and thus absorbs light of 350 nm to 600 nm wavelength, but admits light of 600 nm to 900 nm wavelength adopted as a servo light.

The filter for optical recording medium including the colored material-containing layer and the dielectric material-deposited layer preferably has a function to admit light of first wavelength and reflect light of second wavelength which is different from the first wavelength, wherein first wavelength is preferably 600 nm to 900 nm, and the second wavelength is preferably 350 nm to 600 nm. To achieve this, an optical recording medium in which a recording layer, dielectric material-deposited layer, colored material-containing layer and servo pit pattern are laminated in this order from the optical system is preferable.

The filter layer preferably has an optical transmittance of 50% or more, more preferably 80% or more for light of wavelength 655 nm, and has a reflectivity of 30% or more, more preferably 40% or more for light of wave length 532 nm, both incident at an angle of within ±400.

<Cholesteric Liquid Crystal Layer>

The cholesteric liquid crystal layer contains at least a nematic liquid crystal compound and a chiral compound, and further contains polymerizable monomers, and additional components on as-needed basis.

The cholesteric liquid crystal layer may be either a single-layered cholesteric liquid crystal layer or a multilayered cholesteric liquid crystal layer.

The cholesteric liquid crystal layer preferably has a circularly polarizing function. The cholesteric liquid crystal layer selectively reflects light components which have been circularly polarized in the direction in which the liquid crystal helix rotates (i.e., to the right or left) and which have a wavelength that equals to the pitch of the liquid crystal helix. The cholesteric liquid crystal layer utilizes the selective reflection characteristics to separate a particular circularly polarized component of a particular wavelength from natural light of different wavelengths, and reflects the other light components.

Thus, the cholesteric liquid crystal layer preferably admits light of first wavelength and reflects light of second wavelength which is different from the first wavelength, wherein first wavelength is preferably 350 nm to 600 nm, and the second wavelength is preferably 600 nm to 900 nm.

The cholesteric liquid crystal layer can selectively reflect only light of specific wavelengths; it is difficult to cover wavelengths of visible light. Specifically, the selectively-reflecting wavelength range a is expressed by the following Equation (1):
Δλ=2λ(ne−no)/(ne+no) Equation (1)
where “no” represents the refractive index of the nematic liquid crystal molecules for normal light, contained in the cholesteric liquid crystal layer, “ne” represents the refractive index of the nematic liquid crystal molecules for abnormal light, and λ represents the central wavelength of light selectively reflected.

As can be seen from Equation (1), Δλ is dependent on the molecular structure of the nematic liquid crystal itself, and it is possible to increase Δλ by increasing (ne−no). However, (ne−no) is generally set to 0.3 or less. This is because if (ne−no) is greater than 0.3, it results in poor liquid crystal properties (e.g., alignment characteristics and liquid crystal temperature), making it possible to put the invention to practical use.

Meanwhile, λ—the central wavelength of light selectively reflected—in the cholesteric liquid crystal layer is expressed by the following Equation (2):
λ=(ne+no)P/2 Equation (2)
where “ne” and “no” are identical to those in Equation (1), and “P” represents a helical pitch length for each turn of the cholesteric liquid crystal helix.

As shown in Equation (2), λ is dependent on the mean refractive index and on helical pitch length P of the cholesteric liquid crystal layer if the helical pitch is constant. Thus, to secure a large Δλ value, the cholesteric liquid crystal layers preferably have different λ values and the helices preferably rotate to the same direction (i.e., to the right or left). The ranges of λ in the cholesteric liquid crystal layers are preferably continuous with each other. As used herein “continuous” means that there are no distinct intervals between adjacent λ ranges −λ₀ to λ₀/cos 20° (more preferably λ to λ₀/cos 40°), inside of which reflectivity of 40% or more is substantially ensured.

Accordingly, each interval between λ ranges of the cholesteric liquid crystal layers is preferably within a range which is continuous with at least another λ range.

The filter for optical recording media preferably has a reflectivity of 40% or more for light of a wavelength range of λ₀ to λ₀/cos 20° (where λ₀ re presents the wavelength of irradiation light) incident at an angle of ±20° (measured from the normal of the surface of the recording layer). Most preferably, the filter for optical recording media has a reflectivity of 40% or more for light of a wavelength range of λ₀ to λ₀/cos 40° (where λ₀ represents the wavelength of irradiation light) incident at an angle of ±40° (measured from the normal of the surface of the recording layer). If the optical reflectivity is 40% or more for light of a wavelength range of λ₀ to λ₀/cos 20°, especially λ₀ to λ₀/cos 40° (where λ₀ represents the wavelength of irradiation light), it is made possible to eliminate the dependency of reflectivity on incident angle and to adopt optical lens system that is used for general optical recording media.

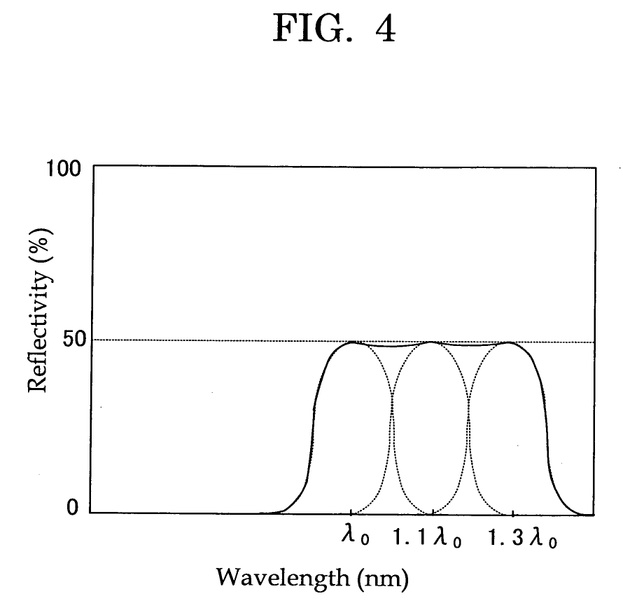

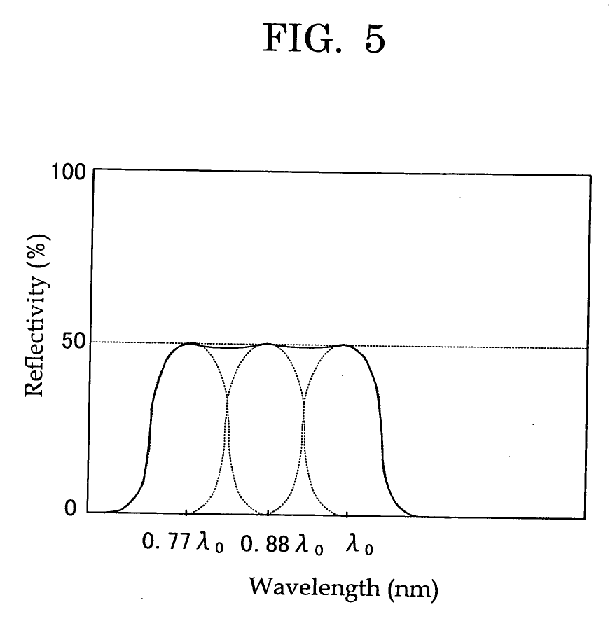

When a multilayered cholesteric liquid crystal layer in which three cholesteric liquid crystal layers with different λ values, where the helices rotate to the same direction, are laminated is used, a filter for optical recording media with reflection characteristics as shown in FIG. 4 can be obtained. FIG. 4 indicates that the reflectivity is 40% or more for light incident from the vertical direction at an angle of 0°. In contrast to this, the reflection characteristics peak gradually shifts to shorter wavelengths as light is incident from the oblique directions, and the reflection characteristics are like that shown in FIG. 5 when light is incident to the liquid crystal layer at an angle of 40°.

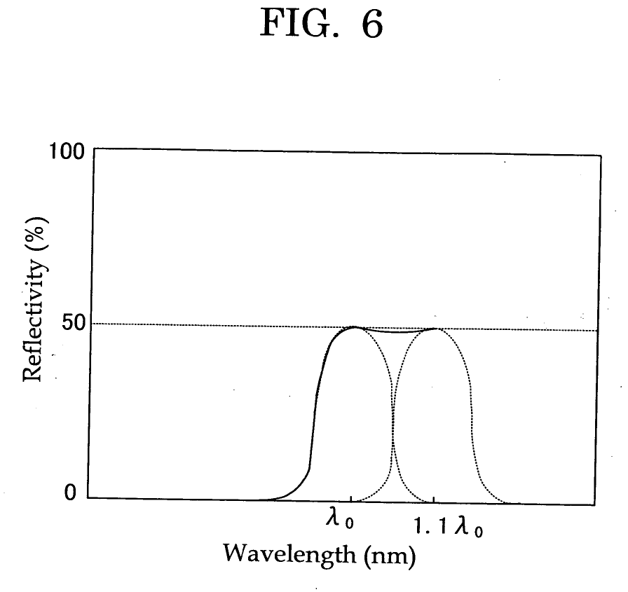

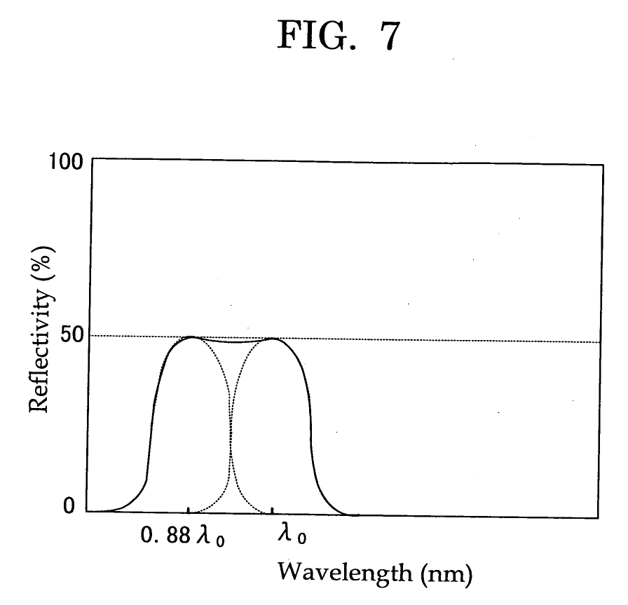

Similarly, when a multilayered cholesteric liquid crystal layer in which two cholesteric liquid crystal layers with different λ values, where the helices rotate to the same direction, are laminated is used, a filter for optical recording media with reflection characteristics as shown in FIG. 6 can be obtained. FIG. 6 indicates that the reflectivity is 40% or more for light incident from the vertical direction at an angle of 0°. In contrast to this, the reflection characteristics peak gradually shifts to shorter wavelengths as light is incident from the oblique directions, and the reflection characteristics are like that shown in FIG. 7 when light is incident to the liquid crystal layer at an angle of 20°.

Note that with respect to the reflection range of λ₀ to 1.3λ₀, shown in FIG. 4, 1.3λ₀ equals to 692 nm when λ₀ is 532 nm, and thus a servo light of wavelength 655 nm is undesirably reflected. This reflection range is set in view of light incident at an angle of ±40°. However, when such light that is incident at larger angles is intended to be used, a servo operation can be performed without causing any problems by using a servo light incident at an angle of within ±20° that has been masked. In addition, by securing larger mean refractive index in cholesteric liquid crystal layers in the filter layer used, it is also possible to readily cover a servo light incident to the filter layer at an angle of within ±20°. In that case, it is only necessary to prepare two-layered cholesteric liquid crystal layer with a reflection range of λ₀ to 1.1λ₀ as shown in FIG. 6. Thus, transmittance of the servo light entails no difficulty.

The reflection characteristics shown in FIGS. 4 to 7 suggest that in the filter for the optical recording medium of the invention, reflectivity of 40% or more is ensured even when light is incident to a multilayered cholesteric liquid crystal layer at an angle of 0° to 20° (more preferably 0° to 40°), thereby making it possible to provide a filter for optical recording media which causes no problems upon reading of signals.

The cholesteric liquid crystal layer is not particularly limited as long as it has the foregoing characteristics, and can be appropriately selected depending on the intended purpose. As described above, the cholesteric liquid crystal layer contains a nematic liquid crystal compound and a chiral compound, and further contains polymerizable monomers, and additional components on as-needed basis.

—Nematic Liquid Crystal Compounds—

The nematic liquid crystal compounds features that their liquid crystal phase solidifies under the liquid crystal transition temperature, and can be appropriately selected from liquid crystal compounds, high-molecular liquid crystal compounds and polymerizable liquid crystal compounds, all of which have refractive index anisotropy Δn of 0.10 to 0.40. For example, such nematic liquid crystal compound molecules that are in the liquid crystal state by treatment with heat can be aligned by use of a surface-rubbed alignment substrate, followed by a cooling treatment or the like to allow them to be immobilized to the substrate to serve as a solid phase.

The nematic liquid crystal compounds are not particularly limited and can be appropriately selected depending on the intended purpose; examples thereof include the compounds listed below.

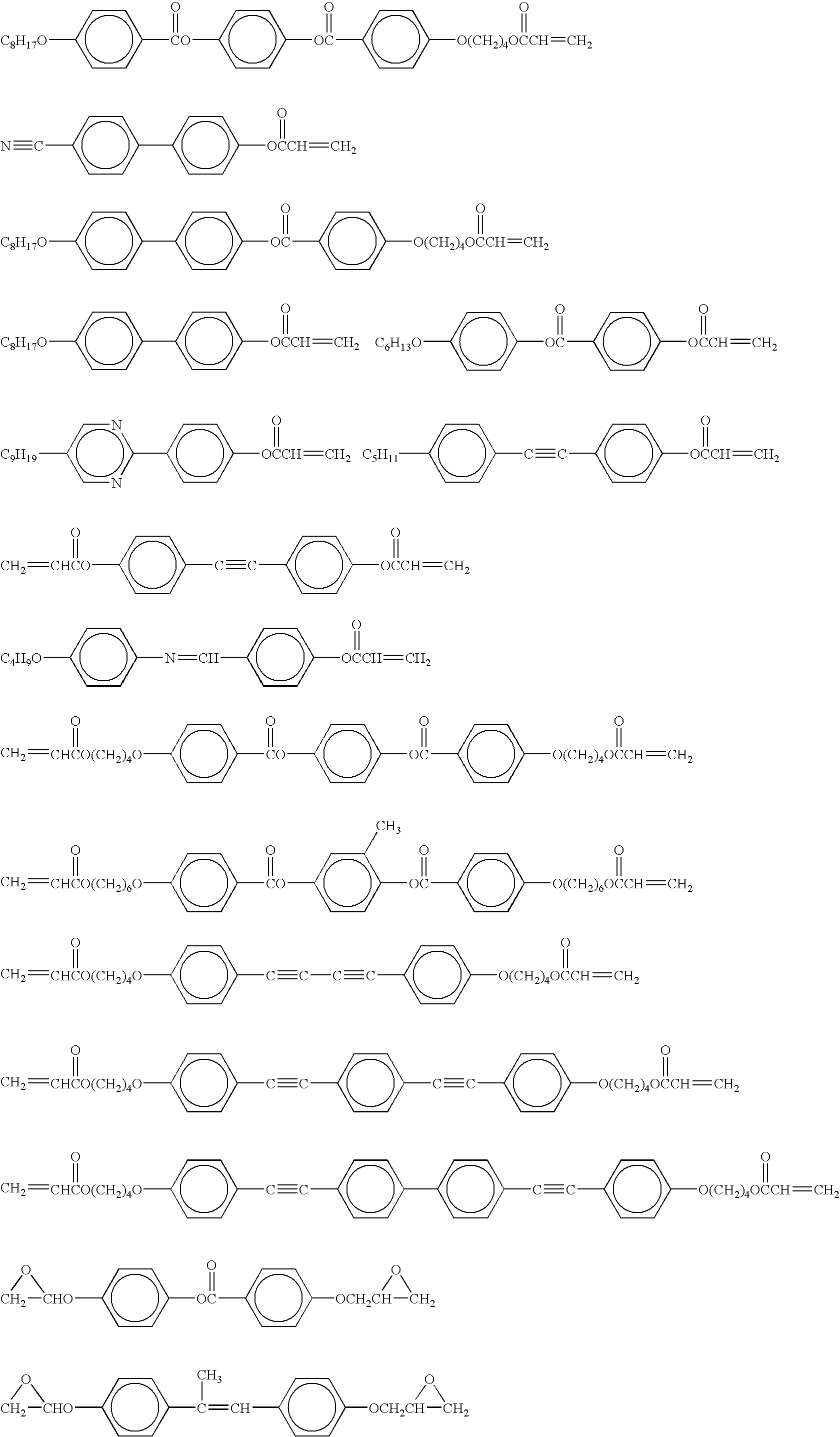

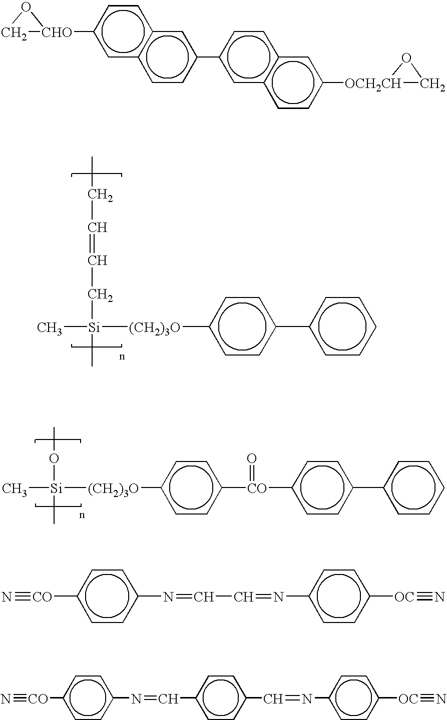

where n represents an integer of 1 to 1,000. Note in each of the listed compounds that spacers connecting between adjacent moieties may be changed those listed below, and such altered compounds are also suitably used.

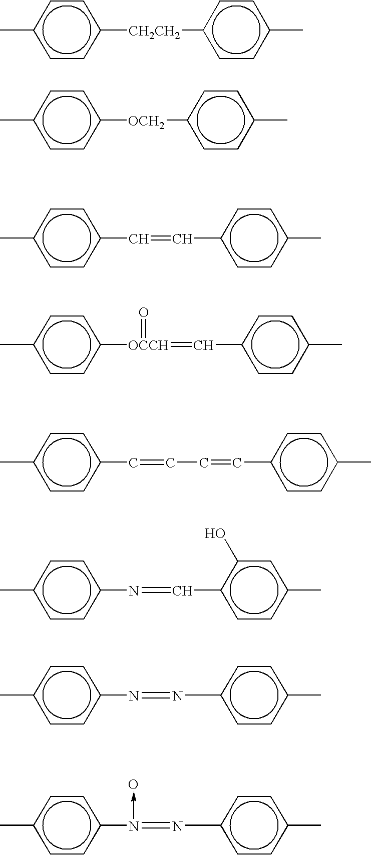

Among the compounds listed above, nematic liquid crystal compounds that have polymerizable groups in their molecule are preferable for the purpose of ensuring sufficient curing capability, and ultraviolet (UV) polymerizable liquid crystal compounds are suitably used. Examples of such ultraviolet (UV) polymerizable liquid crystal compounds include the following commercially available products: PALIOCOLOR LC242 (bland name, produced by BASF Corp.); E7 (bland name, produced by Merck Ltd.); LC-Silicon-CC3767 (bland name, produced by Wacker-Chem); and L35, L42, L55, L59, L63, L79 and L83 (bland name, produced by Takasago International Corp.).

The content of the nematic liquid crystal compound is preferably 30% by mass to 99% by mass, more preferably 50% by mass to 99% by mass of the total solid components in each of the cholesteric liquid crystal layer. If the content of the nematic liquid crystal compound is less than 30% by mass, it may result in poor alignment of nematic liquid crystal molecules.

—Chiral Compounds—

In the case of a multilayered cholesteric liquid crystal layer, the chiral compound is not particularly limited and can be appropriately selected from those known in the art; in view of the hues of the liquid crystal compounds and for enhanced color purity, for example, isomannide compounds, catechine compounds, isosorbide compounds, fenchone compounds and carvone compounds can be used. In addition to these compounds, the compounds listed below can be used. These chiral compounds may be used singly or in combination.

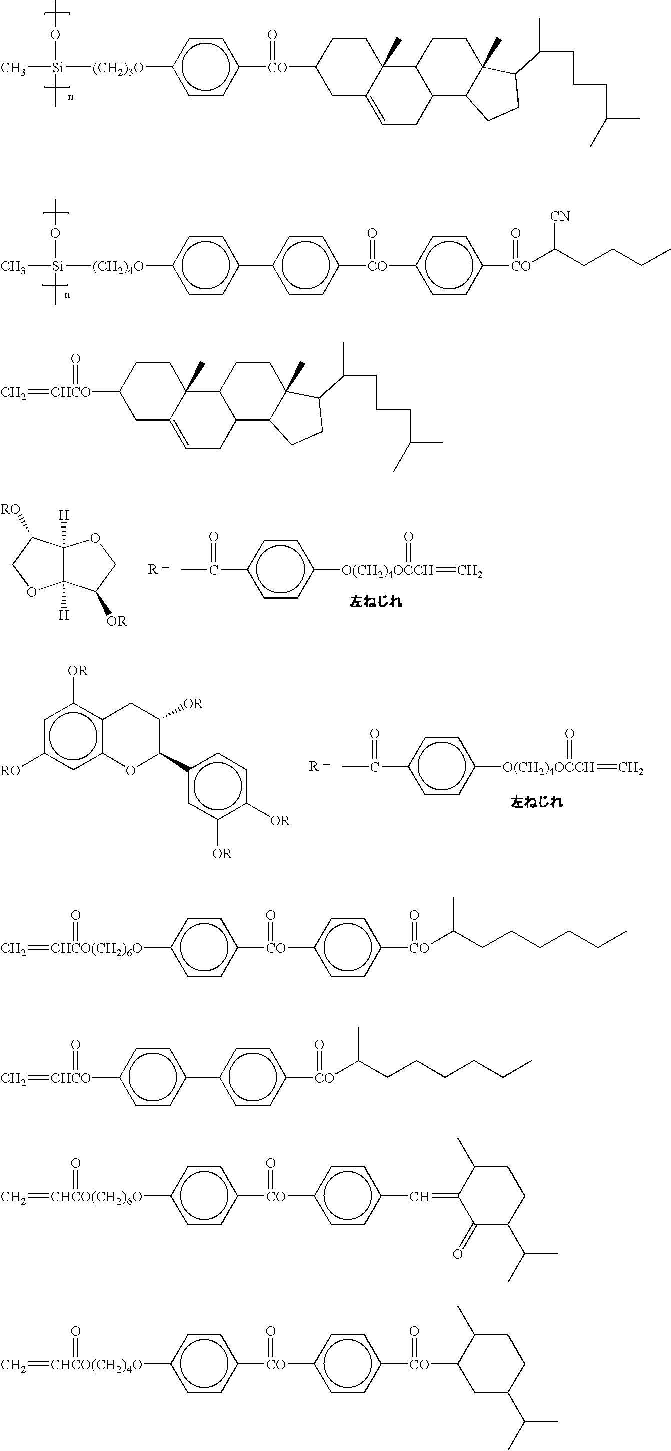

In addition, commercially available chiral compounds can also be used; examples thereof include S101, R811 and CB15 (bland name, produced by Merck Ltd.); and PALIOCOLOR LC756 (bland name, produced by BASF Corp.).

The content of the chiral compound in each liquid crystal layer of the multilayered cholesteric liquid crystal layer is preferably 0% by mass to 30% by mass, more preferably 0% by mass to 20% by mass of the total solid components in each liquid crystal layer. If the content of the chiral compound is greater than 30% by mass, it may result in poor alignment of cholesteric liquid crystal molecules.

—Polymerizable Monomers—

It is also possible to add polymerizable monomers to the cholesteric liquid crystal layer in order to, for example, increase the degree of cure in the layer (e.g., layer strength). Combined use of polymerizable monomers can increase the strength of the cholesteric liquid crystal layer, where different twisting degrees have been set for liquid crystals through which light propagates (e.g., the distribution of wavelengths of light to be reflected has been created) and where the helical structure (i.e., selective reflection capability) has been fixed. Note, however, that such polymerizable monomers need not necessarily be added if the liquid crystal compound bears polymerizable groups in a molecule.

The polymerizable monomers are not particularly limited and can be appropriately selected from those known in the art; examples thereof include monomers bearing ethylenically unsaturated bonds, and specific examples of such monomers include multifunctional monomers such as pentaerythritoltetraacrylate and dipentaerythritolhexaacrylate.

In addition, the compounds listed below can also be cited as specific examples of monomers bearing ethylenically unsaturated bonds. These monomers can be used singly or in combination.

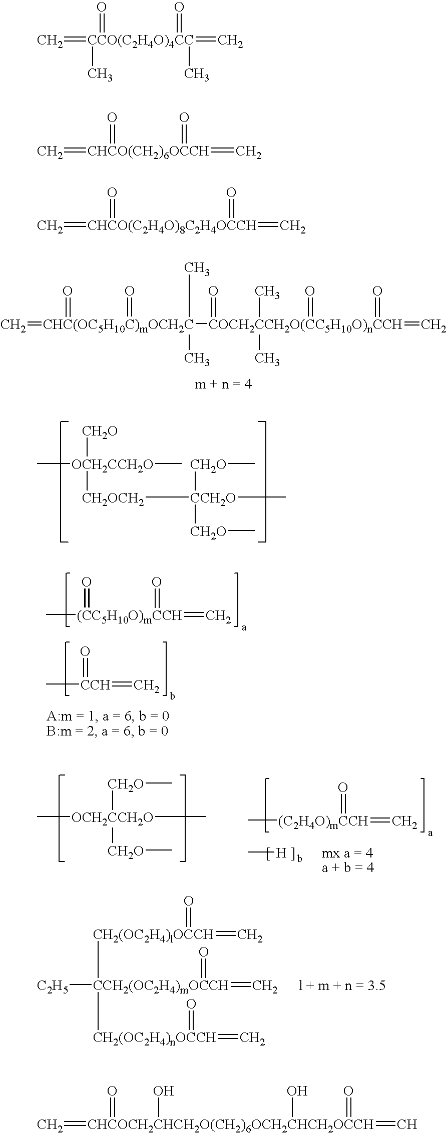

The content of the polymerizable monomers is preferably 50% by mass or less, more preferably 1% by mass to 20% by mass of the total solid components in the cholesteric liquid crystal layer. If the content of the polymerizable monomers is greater than 50% by mass, it may inhibit the alignment of cholesteric liquid crystal molecules.

—Additional Components—

The additional components are not particularly limited and can be appropriately selected depending on the intended purpose; examples thereof include photopolymerization initiators, sensitizers, binder resins, polymerization inhibitors, solvents, surfactants, thickeners, dyes, pigments, ultraviolet absorbers and gelling agents.

The photopolymerization initiators are not particularly limited and can be appropriately selected from those known in the art; examples thereof include p-methoxyphenyl-2,4-bis(trichloromethyl)-s-triazine, 2-(p-buthoxystyryl)-5-trichloromethyl-1,3,4-oxadiazole, 9-phenylacridine, 9,10-dimethylbenzphenazine, benzophenone/Michler's ketone, hexaarylbiimidazole/mercaptobenzoimidazole and benzyldimethylketal, thioxanthone/amine. These photopolymerization initiators may be used singly or in combination.

In addition, commercially available photopolymerization initiators can also be used; examples thereof include IRGACURE 907, IRGACURE 369, IRGACURE 784 and IRGACURE 814 (bland name, produced by Chiba Specialty Chemicals KK); and Lucirin TPO (bland name, produced by BASF Corp.).

The content of the photopolymerization initiator is preferably 0.1% by mass to 20% by mass, more preferably 0.5% by mass to 5% by mass of the total solid components in the cholesteric liquid crystal layer. If the content of the photopolymerization initiator is less than 0.1% by mass, it may take long time for the polymerization because of reduced curing efficiency upon irradiation with light. If the content of the photopolymerization initiator is greater than 20% by mass, it may result in poor optical transmittance over the spectrum from ultraviolet to visible light.

The sensitizer is added on an as-needed basis in order to increase the degree of cure in the cholesteric liquid crystal layer.

The sensitizer is not particularly limited and can be appropriately selected from those known in the art; examples thereof include diethylthioxanthone and isopropylthioxanthone.

The content of the sensitizer is preferably 0.001% by mass to 1% by mass of the total solid components in the cholesteric liquid crystal layer.

The binder resin is not particularly limited and can be appropriately selected from those known in the art; examples thereof include polyvinyl alcohols; polystyrene compounds such as polystyrene and poly-α-methylstyrene; cellulose resins such as methylcellulose, ethylcellulose and acetylcellulose; acid cellulose derivatives bearing carboxylic groups on their side chains; acetal resins such as polyvinyl formal and polyvinyl butyral; methacrylic acid copolymers; acrylic acid copolymers; itaconic acid copolymers; crotonic acid copolymers; malleic acid copolymers; partially-esterified malleic acid copolymers; homopolymers of acrylic acid alkylesters or homopolymers of methacrylic acid alkyl esters; and polymers with additional hydroxyl groups. These binder resins may be used singly or in combination.

Examples of alkyl groups in the homopolymers of acrylic acid alkylesters or homopolymers of methacrylic acid alkyl esters include methyl group, ethyl group, n-propyl group, n-butyl group, iso-butyl group, n-hexyl group, cyclohexyl group and 2-ethylhexyl group.

Examples of the polymers with additional hydroxyl groups include benzyl(meth)acrylate/(homopolymers of methacrylic acid) acrylic acid copolymers, and multicomponent copolymers of benzyl(meth)acrylate/(meth)acrylic acid/other monomers.

The content of the binder resin is preferably 0% by mass to 80% by mass, more preferably 0% by mass to 50% by mass of the total solid components in the cholesteric liquid crystal layer. If the content of the binder resin is greater than 80% by mass, it may result in poor alignment of cholesteric liquid crystal molecules.

The polymerization inhibitor is not particularly limited and can be appropriately selected depending on the intended purpose; examples thereof include hydroquinones, hydroquinone monomethylethers, phenothiazines, benzoquinones and derivatives thereof.

The content of the polymerization inhibitor is preferably 10% by mass or less, more preferably 0.01% by mass to 1% by mass of the total solid components in the polymerizable monomers.

The solvent is not particularly limited and can be appropriately selected from those known in the art; examples thereof include alkoxypropionic acid esters such as 3-methoxypropionic acid methylester, 3-methoxypropionic acid ethylester, 3-methoxypropionic acid propylester, 3-ethoxypropionic acid methylester, 3-ethoxypropionic acid ethylester and 3-ethoxypropionic acid propylester; alkoxy alcohol esters such as 2-methoxypropylacetate, 2-ethoxypropylacetate and 3-methoxybutylacetate; lactic acid esters such as methyl lactate and ethyl lactate; ketones such as methyl ethyl ketone, cyclohexanone and methylcyclohexanone; γ-butyrolactone; N-methylpyrrolidone; dimethylsulfoxide; chloroform; and tetrahydrofuran. These solvents may be used singly or in combination.

The cholesteric liquid crystal layer can be formed in the following procedure: For example, a coating solution for cholesteric liquid crystal layer prepared by use of the solvent is applied on the base material (note that this coating solution is prepared for each liquid crystal layer in the case of a multilayered cholesteric liquid crystal layer). Thereafter, the coating solution is dried, and cured by irradiating it with ultraviolet light.

For mass production, the cholesteric liquid crystal layer can be formed in the following procedure: The base material is previously wound in a roll shape, and the coating solution is then applied on the base material using a long, continuous coater such as a bar coater, die coater, blade coater, or curtain coater.

Examples of the coating method include a spin coating method, casting method, roll coating method, flow coating method, printing method, dip coating method, casting deposition method, bar coating method and gravure printing method.

The UV irradiation condition is not particularly limited and can be appropriately determined depending on the intended purpose; the wavelength of UV light to be applied is preferably 160 nm to 380 nm, more preferably 250 nm to 380 nm; irradiation time is preferably 0.1 second to 600 seconds, more preferably 0.3 second to 300 seconds. By adjusting the UV irradiation condition, it is possible change the helical pitch of the cholesteric liquid crystals continuously in the thickness direction of the liquid crystal layer.

It is also possible to add an ultraviolet absorber to the cholesteric liquid crystal layer in order to adjust the UV irradiation condition. The ultraviolet absorber is not particularly limited and can be appropriately selected depending on the intended purpose; suitable examples thereof include benzophenone ultraviolet absorbers, benzotriazole ultraviolet absorbers, salicylic acid ultraviolet absorbers, cyanoacrylate ultraviolet absorbers and oxalic acid anilide ultraviolet absorbers. Specific examples of these ultraviolet absorbers are disclosed in JP-A Nos. 47-10537, 58-111942, 58-212844, 59-19945, 5946646, 59-109055 and 63-53544; JP-B Nos. 36-10466, 42-26187, 48-30492, 48-31255, 48-41572, 48-54965, and 50-10726; and U.S. Pat. Nos. 2,719,086, 3,707,375, 3,754,919 and 4,220,711.

In the case of a multilayered colesteric liquid crystal layer, the thickness of each cholesteric liquid crystal layer is preferably 1 μm to 10 μm, more preferably 2 μm to 7 μm. If the thickness of the cholesteric liquid crystal layer is less than 1 μm, it results in poor selective reflectivity. If the thickness of the cholesteric liquid crystal layer is greater than 10 μm, uniformly aligned liquid crystal molecules in the cholesteric liquid crystal layer may orient in random directions.

The total thickness of the cholesteric liquid crystal layer in a multilayered cholesteric liquid crystal layer (or the thickness of a single-layered liquid crystal layer) is preferably 1 μm to 30 μm, more preferably 3 μm to 10 μm.

<the Production Process for a Filter for Optical Recording Medium which has a Colesteric Liquid Crystal Layer>

The process for producing the filter is not particularly limited and can be appropriately selected depending on the intended purpose. For example, as described above, the filter can be produced by forming a colored material-containing layer on the base material with a coating method and forming a colesteric liquid crystal on the colored material-containing layer with a coating method.

The filter for optical recording media is not particularly limited and can be appropriately selected depending on the intended purpose. The filter is preferably processed into a disc-shape together with a base material through, for example, a stamping process, and is preferably disposed on the second substrate of an optical recording medium. Alternatively, the filter can be directly disposed on the second substrate without interposing a base material between them in a case where the filter is intended to be used for the filter layer of the optical recording medium.

The filter for optical recording media, in which a colored material-containing layer and a cholesteric liquid crystal layer are combined, preferably has an optical transmittance of 80% or more for light 655 nm wavelength and has a reflectivity of 40% or more for light 532 nm wavelength, both incident to the filter layer at an angle within ±20°.

More specifically, the filter for optical recording media having a dielectric material-deposited layer on a colored material-containing layer shows sufficient reflection characteristics for light incident from the vertical direction (0°). In contrast to this, the reflection characteristics peak shifts to shorter wavelengths as light is incident from the oblique directions, and the reflection characteristics are deteriorated when the light is incident at an angle of 200.

In the filter for the optical recording medium, reflectivity of 40% or more is ensured for light of 532 nm wavelength even when the light is incident at an angle of 0° to 20° and thus no problems occur upon reading of signals, and leaked light (wavelength=532 nm) that has passed through the filter is absorbed while admitting a servo light (wavelength=655 nm), whereby the occurrence of noise can be prevented.

<Base Material>

The base material is not particularly limited and can be appropriately selected depending on the intended purpose. For example, materials used for the foregoing support for the first form may be used.

The base material may be either a freshly prepared one or a commercially available one.

The thickness of the base material is not particularly limited and can be appropriately set depending on the intended purpose; the thickness is preferably 10 μm to 500 μm, more preferably 50 μm to 300 μm. If the thickness of the base material is less than 10 μm, the substrate bends and thus its adhesion properties with other components are reduced. If the thickness of the base material is greater than 500 μm, the focus of information light needs to be shifted by a large amount from the focus of a reference light, leading to the necessity of preparing a big optical system.

The filter for optical recording media can be used in various fields, can be suitably used for the manufacturing or formation of the holographic optical recording media, and can be most suitably used for the holographic optical recording medium of the invention and production method thereof, and for optical recording method and reproducing method described below.

—Optical Recording Medium Having a Reflective Film, and First and Second Gap Layers—

The optical recording medium includes a first substrate, a second substrate, a recording layer provided on the second substrate, and a filter layer provided between the second substrate and the recording layer. The optical recording medium may further include a reflective film, a first gap layer and a second gap layer, and additional layers on an as-needed basis.

The foregoing filter for optical recording medium can be used for the recording layer and filter layer.

—Substrate—

The shape, structure, size and the like of the substrate are not particularly limited and can be appropriately set depending on the intended purpose; examples of the shape of the substrate includes a disc shape and card-like shape, and material that can ensure the mechanical strength of the resultant optical recording medium needs to be selected. In addition, when light for recording and reproduction is incident through the substrate, the substrate needs to be transparent enough to admit such light of desired wavelengths.

For the material of the substrate, glass, ceramics, resins and the like are generally used; however, resin is most preferable in view of the formability and cost.

Examples of the resins include polycarbonate resins, acrylic resins, epoxy resins, polystyrene resins, acrylonitrile-styrene copolymers, polyethylene resins, polypropylene resins, silicone resins, fluorine resins, ABS resins and urethane resins. Among these, polycarbonate resins and acrylic resins are most preferable in view of their formability, optical characteristics, and costs.

The substrate may be either a freshly prepared one or a commercially available one.

Multiple numbers of address-servo areas—addressing areas linearly extending in the radial direction of the substrate—are provided on the substrate at given angles to one another, and each fan-shaped area between adjacent address-servo areas serves as a data area. In the address-servo areas, information for performing a focus servo operation and a tracking servo operation by means of a sampled servo system and address information are previously recorded (or pre-formatted) in the form of emboss pits (servo pits). The focus servo operation can be performed using a reflective surface of the reflective film. For example, wobble pits are used as the information for tracking servo. Note that there is no need to provide the servo pit pattern in a case where the optical recording medium is card-like shape.

The thickness of the substrate is not particularly limited and can be appropriately set depending on the intended purpose; the thickness is preferably 0.1 mm to 5 mm, more preferably 0.3 mm to 2 mm. If the thickness of the substrate is less than 0.1 mm, the optical disc may become deformed during storage. If the thickness is greater than 5 mm, the weight of the optical disc is increased, so too does the load on a drive motor that spins it.

—Reflective Film—

The reflective film is formed on the surface of the servo pit pattern of the substrate.

For the material of the reflective film, materials that offer high reflectivity to a recording light and reference light are preferable. When the wavelength of light to be adopted is 400 nm to 780 nm, Al, Al alloys, Ag, Ag alloys and the like are preferably used. When the wavelength of light to be adopted is 650 nm or more, Al, Al alloys, Ag. Ag alloys, Au, Cu alloys, TiN and the like are preferably used.

By using an optical recording medium which reflects light by a reflective film and can record or erase information—for example, DVD (Digital Versatile (Video) Disc), directory information indicative of the locations where information has been recorded, the time when information has been recorded, and the locations where errors have occurred and how information has been re-recorded on spare areas can also be recorded on, and erased from the optical recording medium without adversely affecting holograms.

The method for forming the reflective film is not particularly limited and can be appropriately selected depending on the intended purpose; examples thereof include various types of vapor deposition, such as a vacuum vapor deposition, sputtering, plasma CVD, photo CVD, ion plating, and electron beam vapor deposition. Among these, sputtering is most preferable in view of mass productivity, film quality, and the like.

The thickness of the reflective film is preferably 50 nm or more, more preferably 100 nm or more, in order to secure sufficient reflectivity.

—First Gap Layer—

The first gap layer is provided between the filter layer and the reflective film on an as-needed basis for smoothing the surface of the second substrate. Moreover, the first gap layer is effective to adjust the size of holograms formed in the recording layer. Specifically, since somewhat large regions where optical interference between information light and recording reference light takes place need to be secured in the recording layer, it is effective to provide the first gap layer between the recording layer and the servo pit pattern.

The first gap layer can be formed by, for example, applying UV curable resin or the like on the servo pit pattern by spin coating or the like and by curing the resin. In addition, when a filter layer is formed on a transparent base material, the transparent base material also serves as the first gap layer.

The thickness of the first gap layer is not particularly limited and can be appropriately set depending on the intended purpose; the thickness is preferably 1 μm to 200 μm.

—Second Gap Layer—

The second gap layer is provided between the recording layer and the filter layer on an as-needed basis.

The material for the second gap layer is not particularly limited and can be appropriately selected depending on the intended purpose; examples thereof include transparent resin films such as triacetylcellulose (TAC), polycarbonate (PC), polyethylene terephthalate (PET), polystyrene (PS), polysulfone (PSF), polyvinylalcohol (PVA) and methyl polymethacrylate (PMMA); norbornene resin films such as ARTON (bland name, produced by JSR Corp.), ZEONOA (bland name, produced by Nippon Zeon). Among these, those with high isotropy are preferable, and TAC, PC, ARTON and ZEONOA are most preferable.

The thickness of the second gap layer is not particularly limited and can be appropriately set depending on the intended purpose; the thickness is preferably 1 μm to 200 μm.

Hereinafter, specific examples of the optical recording medium of the invention, which includes the reflective film and the first and second gap layers, will be described in detail with reference to the drawings.

<Specific Example of Optical Recording Medium>

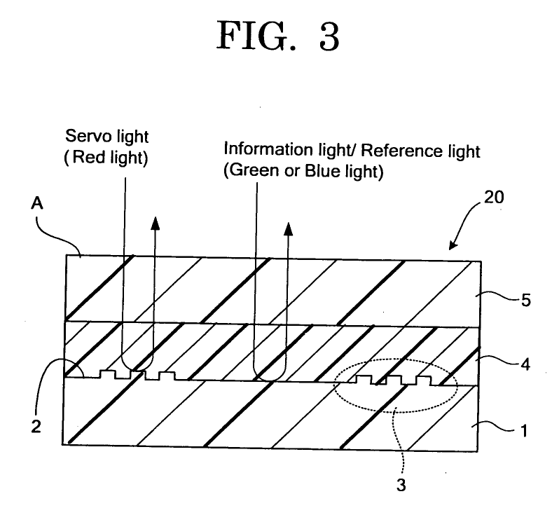

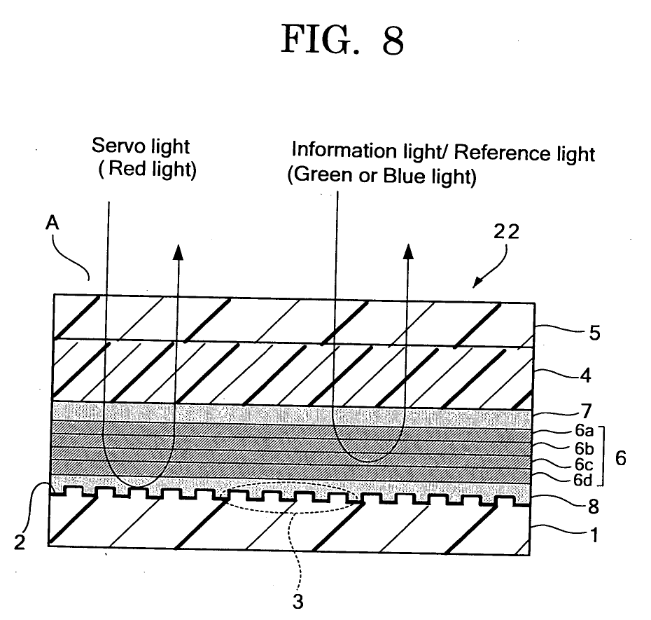

FIG. 8 is a schematic cross-sectional view showing the structure of the optical recording medium of specific example 1 in the invention. In an optical recording medium 22 according to this specific example 1 a servo pit pattern 3 is formed on a second substrate 1 made of polycarbonate resin or glass, and the serve pit pattern 3 is coated with Al, Au, Pt or the like to form a reflective film 2. Although the servo pit pattern 3 is formed on the entire surface of the second substrate 1 in FIG. 8, it may be formed on the second substrate 1 periodically as shown in FIG. 3. In addition, the height of the servo pit pattern 3 is generally 1,750 angstrom (175 nm), far smaller than those of the other layers, including substrates.

A first gap layer 8 is formed by applying UV curable resin or the like on the reflective film 2 of the second substrate 1 by spin coating or the like. The first gap layer 8 is effective for protecting the reflective film 2 and for adjusting the size of holograms created in a recording layer 4. Specifically, since somewhat large regions where optical interference between information light and recording reference light takes place need to be secured in the recording layer 4, it is effective to provide clearance between the recording layer 4 and the servo pit pattern 3.

A filter layer 6 is provided on the first gap layer 8, and the recording layer 4 is sandwiched between the filter layer 6 and a first substrate 5 (a polycarbonate resin substrate or glass substrate) to constitute the optical recording medium 21.

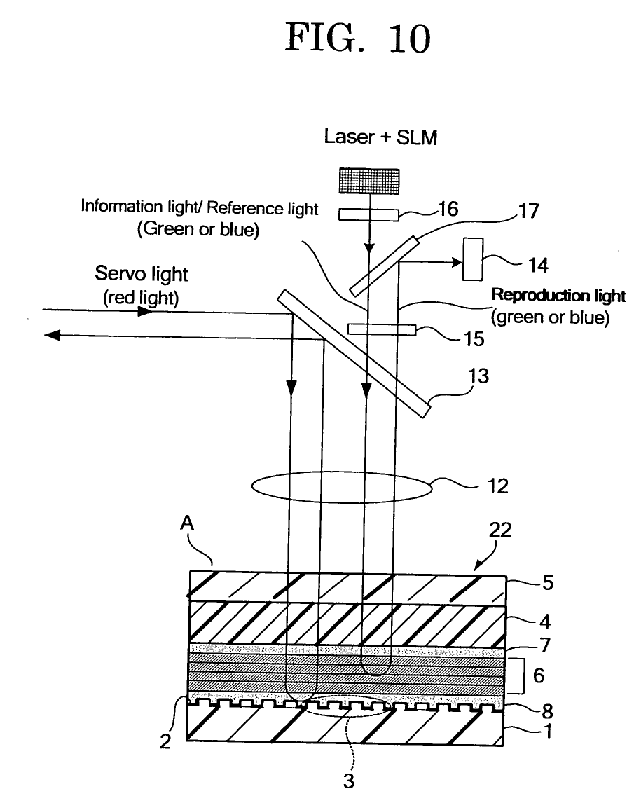

In FIG. 10 the filter layer 6 admits only red light and reflects light of the other colors. Therefore, the information light and recording and reproduction light do not pass through the filter layer 6 because they are light of green or blue, and never reach the reflective film 2, becoming returning light emitting from the light entrance/exit surface A.

The filter layer 6 is constituted of a single-layered cholesteric liquid crystal layer whose helical pitch is continuously changed in the thickness direction thereof. The filter layer 6 may be directly provided on the first gap layer 8 with a coating method, or may be provided by stamping a film in which a cholesteric liquid crystal layer is formed on a base material into the optical disc shape. By using such a single-layered cholesteric liquid crystal layer, reflectivity of 40% or more can be realized for light of a wavelength range of λ₀ to λ₀/cos 20°, especially λ₀ to λ₀/cos 40° (where λ₀ represents the wavelength of irradiation light), thereby eliminating the fluctuations in the selectively-reflecting wavelength range even when the incident angle has changed.

The optical recording medium 22 of specific example may be a disc shape or card-like shape. There is no need to provide a servo pit pattern in a case where the optical recording medium 22 is a card-like shape. In the optical recording medium 22 the second substrate 1 is 0.6 mm in thickness, the first gap layer 8 is 100 μm in thickness, the filter layer 6 is 2 μm to 3 μm in thickness, the recording layer 4 is 0.6 mm in thickness, and the first substrate 5 is 0.6 mm in thickness, bringing to the total to about 1.9 mm.

Next, optical operations around the optical recording medium 22 will be described with reference to FIG. 10.

First, a red light emitted from the servo laser source is reflected by a dichroic mirror 13 by almost 100%, and passes through an objective lens 12. By this, the servo light is applied onto the optical recording medium 22 in such a way that it focuses on the reflective film 2. More specifically, the dichroic mirror 13 is so configured that it admits only green or blue light but reflects almost 100% of red light. The servo light incident from the light entrance/exit surface A of the optical recording medium 22 passes through the first substrate 5, recording layer 4, filter layer 6 and first gap layer 8, is reflected by the reflective film 2, and passes again through the first gap layer 8, filter layer 6, recording layer 4 and first substrate 5 to emit from the light entrance/exit surface A. The returning servo light passes through the objective lens 12 and is reflected by the dichroic mirror 13 by almost 100%, and then a servo information detector (not shown) detects servo information in the returning servo light. The detected servo information is used for the focus servo operation, tracking servo operation, slide servo operation, and the like. The holographic material constituting the recording layer 4 is designed so as not to be sensitive to red light. For this reason, even when the servo light has passed through the recording layer 4 or has been reflected diffusively by the reflective film 2, the recording layer 4 is not adversely affected. In addition, the returning servo light that has been reflected by the reflective film 2 is reflected by the dichroic mirror 13. Accordingly, the servo light is not detected by a CMOS sensor or CCD 14 used for the detection of reconstructed images, and thus does not interfere with the operation of a reproduction light.

Note that with respect to the reflection range of λ₀ to 1.3λw, 1.3λ₀ shown in FIG. 4, 1.3λ₀ equals to 692 nm when λ₀ is 532 nm, and thus a servo light of wavelength 655 nm is undesirably reflected. This reflection range is set in view of light incident at an angle of ±40°. However, when such light that is incident at larger angles is intended to be used, a servo operation can be performed without causing any problems by using a servo light incident at an angle of within ±20° that has been masked. In addition, by securing larger helical pitch in the cholesteric liquid crystal layer in the filter layer used, it is also possible to readily cover a servo light incident to the filter layer at an angle of within 120°. In that case, it is only necessary to prepare a cholesteric liquid crystal layer with a reflection range of λ₀ to 0.1λ₀ as shown in FIG. 6. Thus, transmittance of the servo light entails no difficulty.

Both the information light and recording reference light generated in the recording/reproduction laser source pass through a polarizing plate 16 and are linearly polarized. The linearly polarized light then pass through a half mirror 17 and are circularly polarized after passing through a quarter wave plate 15. The circularly polarized light then pass through the dichroic mirror 13 and the objective lens 12, and are applied onto the optical recording media 22 in such a way that optical interference takes place between the information light and recording reference light to create interference patterns in the recording layer 4. The information light and recording reference light are incident from the light entrance/exit surface A and interact with each other in the recording layer 4 to form an interference pattern to be recorded there. Thereafter, the information light and recording reference light pass through the recording layer 4, launching into the filter layer 6. There, before reaching the bottom of the filter layer 6, the information light and recording reference light are reflected and become returning light. More specifically, the information light and recording reference light do not reach the reflective film 2. This is because the filter layer 6 is formed of a single-layered cholesteric liquid crystal layer whose helical pitch is continuously changed in the thickness direction thereof and thus admits only red light. Moreover, if the intensity of light that has undesirably passed through the filter layer 6 is suppressed to 20% or less of that of the incident light, there will be no practical problems even when such light reaches the bottom of the filter layer 6 and is reflected back as a returning light, because this returning light is again reflected by the filter layer 6 and its intensity in a reproduction light is as small as 4% (20%×20%) or less of that of the reproduction light.

(Method for Producing Optical Recording Medium)

The method for producing an optical recording medium of the invention comprises a step of preparing a composition that prepares the composition for optical recording of the invention, a step of disposing a recording layer that disposes the recording layer containing the composition for optical recording, and a step of forming a filter layer, and may further comprise a step of forming a reflective film and additional steps on an as-needed basis.

—Step of Preparing Composition—

The step of preparing a composition is a step in which the epoxide compound and the curing agent, which are raw materials of matrix polymer, are mixed and further photopolymer components, a polymerizable monomer and photopolymerization initiator, and a curing catalyst for promoting curing are mixed uniformly. Here, the epoxide compound and the curing agent are mixed such that when the ratio of the solid component of the epoxide compound is set to 1, the curing agent preferably ranges from 0.7 to 1.3, more preferably ranges from 0.8 to 1.2. In addition, solution is preferably prepared at a temperature ranging from 10° C. to 30° C. with humidity ranging from 10% to 50%. Within this range, it is possible to prepare compositions that have excellent flexibility, is resistant to change in temperature and humidity, and exhibits satisfactory properties as a composition for optical recording.

—Filter Layer Formation Step—

The filter layer formation step is a step in which the filter for optical recording medium of the invention is processed into the optical recording medium shape, and the processed filter is bonded to the second substrate to form a filter layer. The process for producing the filter for the optical recording medium of the invention is as described above.

The shape of the optical recording medium is, for example, disc shape or card-like shape.

The method for processing the filter into the optical recording medium shape is not particularly limited, and can be appropriately selected depending on the intended purpose. For example, a cutting process with a press cutter, or a stamping process with a stamping cutter can be used. The filter is bonded to the second substrate by use of, for example, an adhesive or agglutinant while avoiding entry of air bubbles.

The adhesive is not particularly limited and can be appropriately selected depending on the intended purpose; examples thereof include UV curable adhesives, emulsion adhesives, one-component curable adhesives and two-component curable adhesives. These known adhesives can be used in any combination.

The agglutinant is not particularly limited and can be appropriately selected depending on the intended purpose; examples thereof include rubber agglutinants, acrylic agglutinants, silicone agglutinants, urethane agglutinants, vinylalkyl ether agglutinants, polyvinylalcohol agglutinants, polyvinylpyrrolidone agglutinants, polyacrylamide agglutinants and cellulose agglutinants.

The thickness of the adhesive or agglutinant applied is not particularly limited and can be appropriately set depending on the intended purpose. In the case of adhesive, the thickness is preferably 0.1 μm to 10 μm, more preferably 0.1 μm to 5 μm in light of the optical characteristics and slimness. In the case of agglutinant, the thickness is preferably 1 μm to 50 μm, more preferably 2 μm to 30 μm.

Note, however, that it is possible to directly form the filter layer on the substrate depending on the circumstances. For example, a coating solution for colored material-containing layer is applied onto the substrate to form a colored material-containing layer, and a dielectric thin film is formed on the colored material-containing layer by sputtering or the like.

—Step of Disposing Recording Layer—

The step of disposing a recording layer is a step in which a recording layer for recording information by holography is disposed on the filter layer and the recording layer is disposed by applying the composition for optical recording of the invention, prepared in the step of preparing a composition.

<Method for Reproducing Recorded Optical Information>

The method for reproducing recorded optical information is not particularly limited and can be appropriately selected depending on the intended purpose. For example, reproduction of recorded optical information is performed by applying a reference light to an optical recording medium, where information has been recorded with the optical recording method of the invention, from the same direction as the reference light for recording is applied. Applying the reference light to an interference image formed in the recording layer of the optical recording medium creates a reproduction light that corresponds to the interference image, and the optical information is reproduced by collecting it.

Hereinafter, Examples of the invention will be described, which however shall not be construed as limiting the invention thereto.

The composition for optical recording of the invention was prepared, an optical recording medium, in which a recording layer comprising the composition for optical recording was disposed, was prepared, the odor during preparation was evaluated by a sensory test, and defect of the recording layer was examined.

Further, information light and reference light were applied onto the resulting optical recording medium to form an interference image which was recorded in the recording layer. In addition, the temporal stability of the prepared composition for optical recording was evaluated. When the optical recording medium is prepared, the recording layer is disposed either over the substrate on which the filter for the optical recording medium is disposed or on a transparent support. In Examples 1 to 7 and Comparative Examples 1 to 3, the recording layer was disposed over the substrate on which the filter for the optical recording medium was disposed.

### EXAMPLE 1

<Preparation of Filter for Optical Recording Medium>

—Formation of Colored Material-Containing Layer—

Initially, polyvinyl alcohol (bland name: MP 203, produced by Kuraray Co., Ltd.) was applied on a polycarbonate film of 100 μm thickness (bland name: lupilon, produced by Mitsubishi Gas Chemical Company Inc.) to the thickness of 1 μm to prepare a base film.

Next, a coating solution for colored material-containing layer having the following components was prepared by a conventional method.

Red pigment (C. I. Pigment Red 9). 10 Parts by mass

Binder resin (Polyvinylalcohol resin, produced by Kuraray Co., Ltd.) . . . 100 Parts by mass

Water . . . 700 Parts by mass

Next, the coating solution for colored material-containing layer was applied on the base film with a bar coater and dried to form a colored material-containing layer of 3 μm thickness.

—Simulation of Dielectric Material-Deposited Layer—

Next, using an optical thin film calculation software TFCalc (bland name, produced by Software Spectra, Inc.), computer simulation was conducted on the dielectric material-deposited layer with various numbers of dielectric thin films according to the following conditions for calculation.

<Conditions for Calculation>

For the refractive indices of TiO₂ and MgF₂, those in the data base of TFCalc were used.

Film thickness was optimized so that the reflectivity at 535 nm and optical transmittance at 650 nm were as high as possible, respectively.

The refraction index of medium was set to 1.52.

Calculation was carried out using wavelength of 535 nm for recording and of 650 nm for tracking. Combinations such as 535 nm for recording and 780 nm for tracking, 405 nm for recording and 650 nm for tracking, or 405 nm for recording and 780 nm for tracking may also be used.

<Three-Layer Stack>

The result of the simulation when three layers of dielectric thin film were laminated as shown in Table 1 is shown in Table 2.

TABLE 1

| | Material | Film thickness (nm) |
|---|---|---|
| Third layer from light | TiO₂ | 54.1 |
| incident side | | |
| Second layer from | MgF₂ | 83.8 |
| light incident side | | |
| First layer from light | TiO₂ | 54.1 |
| incident side | | |

TABLE 2

Angle
(Inside medium)

| | 0° | 40° |
|---|---|---|
| Reflectivity at 535 nm | 56.8% | 41.4% |
| Optical transmittance at | 62.7% | 81.0% |
| 650 nm | | |

<Five-Layer Stack>

The result of the simulation when five layers of dielectric thin film were laminated as shown in Table 3 is shown in Table 4.

TABLE 3

| | Material | Film thickness (nm) |
|---|---|---|
| Fifth layer from light | TiO2 | 63.9 |
| incident side | | |
| Fourth layer from light | MgF2 | 62.8 |
| incident side | | |
| Third layer from light | TiO2 | 62.6 |
| incident side | | |
| Second layer from light | MgF2 | 62.8 |
| incident side | | |
| First layer from light | TiO2 | 63.9 |
| incident side | | |

TABLE 4

Angle
(Inside medium)

| | 0° | 40° |
|---|---|---|
| Reflectivity at 535 nm | 76.9% | 43.5% |
| Optical transmittance at | 70.4% | 98.9% |
| 650 nm | | |

<Seven-Layer Stack>

The result of the simulation when seven layers of dielectric thin film were laminated as shown in Table 5 is shown in Table 6.

TABLE 5

| | Material | Film thickness (nm) |
|---|---|---|
| Seventh layer from light | TiO2 | 59.4 |
| incident side | | |
| Sixth layer from light | MgF2 | 61.3 |
| incident side | | |
| Fifth layer from light | TiO2 | 67.0 |
| incident side | | |
| Fourth layer from light | MgF2 | 67.3 |
| incident side | | |
| Third layer from light | TiO2 | 67.0 |
| incident side | | |
| Second layer from light | MgF2 | 61.3 |
| incident side | | |
| First layer from light | TiO2 | 59.4 |
| incident side | | |

TABLE 6

Angle
(Inside medium)

| | 0° | 40° |
|---|---|---|
| Reflectivity at 535 nm | 90.1% | 44.3% |
| Optical transmittance | 81.7% | 90.8% |
| at 650 nm | | |

<Nine-Layer Stack>

The result of the simulation when nine layers of dielectric thin film were laminated as shown in Table 7 is shown in Table 8.

TABLE 7

| | Material | Film thickness (nm) |
|---|---|---|
| Ninth layer from light | TiO2 | 64.0 |
| incident side | | |
| Eighth layer from light | MgF2 | 70.0 |
| incident side | | |
| Seventh layer from light | TiO2 | 56.7 |
| incident side | | |
| Sixth layer from light | MgF2 | 77.1 |
| incident side | | |
| Fifth layer from light | TiO2 | 65.6 |
| incident side | | |
| Fourth layer from light | MgF2 | 77.1 |
| incident side | | |
| Third layer from light | TiO2 | 56.7 |
| incident side | | |
| Second layer from light | MgF2 | 70.0 |
| incident side | | |
| First layer from light | TiO2 | 64.0 |
| incident side | | |

TABLE 8

Angle
(Inside medium)

| | 0° | 40° |
|---|---|---|
| Reflectivity at 535 nm | 96.9% | 47.1% |
| Optical transmittance | 91.6% | 85.4% |
| at 650 nm | | |

The above-mentioned results of simulation indicate that in the case where three to nine layers of dielectric thin film were laminated, practical results of reflection characteristics were obtained and it was confirmed that seven layers were most preferable to be laminated in terms of the balance between reflection characteristics and productivity.

—Formation of Dielectric Material-Deposited Filter—

Initially, dipentaerythritolhexaacrylate (produced by Nippon Kayaku Co., Ltd.) was applied on a triacetylcellulose film of 100 μm thickness (bland name: Fujitac 12/3, produced by Fuji Photo Film Co., Ltd.) to the thickness of 0.5 μm to prepare a base material film.

Next, on the base material film seven layers were laminated by sputtering (Cube, produced by Unaxis Co.) according to a multi-chamber method in the same configuration as that of the seven layer stack in the above-mentioned simulation to prepare a dielectric material-deposited filter.

The dielectric material-deposited filter was bonded to the base film provided with the colored material-containing layer by use of an adhesive to prepare a filter for optical recording medium.

Optical characteristics measurements were made for the filter for optical recording medium using a spectral reflectometer equipped with L-5662, a light source manufactured by Hamamatsu Photonics KK and with PMA-11, a photomultichannel analyzer manufactured by Hamamatsu Photonics KK.

The measurement results indicated that the filter in Example 1 could reflect 30% or more of light of wavelength 532 nm—light of wavelength selected as being reflected—incident at an angle of within ±40°.

—Preparation of Optical Recording Medium—

An optical recording medium was prepared that comprises a first substrate, second substrate, recording layer, and filter layer.

For the second substrate, a polycarbonate resin substrate of 120 mm in diameter, 15 mm in inner diameter, and 0.6 mm thickness was used that is generally used for DVD+RW. A servo pit pattern is formed all over the surface of the substrate, with the track pitch being 0.74 μm, the groove depth 140 nm, and groove width 300 nm.

At first, a reflective film made of silver (Ag) was deposited on the surface of the servo pit pattern of the second substrate to the thickness of 150 nm with a DC magnetron sputtering method. A polycarbonate film of 100 μm thickness as a first gap layer was bonded to the reflective film with UV curable resin.

Next, the resultant filter was stamped into a disc shape of predetermined size, so that the filter could be arranged on the substrate. The disc-shaped filter was bonded to the substrate, with its base film side being in contact with the servo pit pattern side. Note that the filter was bonded to the substrate by use of UV curable resin and an agglutinant while avoiding entry of air bubbles. In this way a filter layer was formed.

As the composition for optical recording, a solution containing the following components was prepared. The solution was prepared in the atmosphere of temperature 25° C. and humidity 40%. The viscosity of the composition for optical recording at 30 minutes after the preparation was measured with a viscometer (VISCOMATE VM-10A, produced by CBC Co., Ltd.)

Composition for Optical Recording (A)

Polypropylene glycol diglycidyl ether (Epolight 400P, produced by Kyoeisha Chemical Co., Ltd.) . . . 71% by mass

Methylhexahydrophthalic anhydride (Rikacid MR-700, produced by New Japan Chemical Co., Ltd.) . . . 17% by mass

Curing catalyst DBU (produced by Tokyo Chemical Industry Co., Ltd.) . . . 4.0% by mass

Polymerizable monomer tribromophenoxyethyl acrylate (BR-31, produced by Dai-Ichi Kogyo Seiyaku Co., Ltd.) . . . 7.3% by mass

Photopolymerization initiator IRGACURE 784 (produced by Ciba Speciality Chemicals) . . . 0.74% by mass

Thus prepared solution of composition for optical recording was poured over the substrate wherein an outer bank with an outer circumference of 120 mm, inner circumference of 116 mm, and thickness of 200 μm and an inner bank with an outer circumference of 36 mm and inner circumference of 15 mm were formed on the filter layer with an adhesive. Further, a cover substrate made of polycarbonate resin with an outer circumference of 120 mm, inner circumference of 15 mm, and thickness of 0.6 mm was disposed and heat cured at 100° C. for 1 hour with an outer and inner peripheral regions fixed with a fixing tool to obtain an optical recording medium. FIG. 2 is a schematic cross-sectional view representing a similar form as that of this Example.

—Evaluation of State of Layer—

The layer of the resulting recording layer where the composition for optical recording has cured was observed with a confocal optical microscope in the direction of depth and the thickness of the recording layer was evaluated by determining the interface based on the index difference from the substrate. Evaluation results are shown in Table 9.

—Recording on Recording Layer—

Nd:YVO4 laser (VECTOR 532-1000-20, produced by Coherent, Inc., wavelength 532 nm and output power 1W) output was used as a light source and was applied, as information light and reference light, onto the medium. Interference fringes were produced, which were recorded on the recording layer. Whether interference fringes were drawn with an irradiation energy of 1 J/cm² or less was determined by applying red laser (RADIUS 635-25, produced by Coherent, Inc., output wavelength 635 nm) and confirming the presence or absence of reproduction light.

In Examples 2 to 5, compositions for optical recording were prepared using the following components, optical recording media were prepared in the same way as in Example 1, and the same evaluation as in Example 1 was conducted. Results are shown in Table 2.

Composition for Optical Recording (B)

Polyethylene glycol diglycidyl ether (Epolight 400E, produced by Kyoeisha Chemical Co., Ltd.) . . . 73% by mass

Methylhexahydrophthalic anhydride (Rikacid MH-700, produced by New Japan Chemical Co., Ltd.) . . . 15% by mass

Curing catalyst DBU (produced by Tokyo Chemical Industry Co., Ltd.) . . . 4.0% by mass

Polymerizable monomer tribromophenoxyethyl acrylate (BR-31, produced by Dai-Ichi Kogyo Seiyaku Co., Ltd.) . . . 7.3% by mass

Photopolymerization initiator IRGACURE 784 (produced by Ciba Speciality Chemicals) . . . 0.74% by mass

Composition for Optical Recording (C)

Polyethylene glycol diglycidyl ether (Epolight 400E, produced by Kyoeisha Chemical Co., Ltd.) . . . 64% by mass

Methylhexahydrophthalic anhydride (Rikacid MH-700, produced by New Japan Chemical Co., Ltd.) . . . 24% by mass

Curing catalyst DBU (produced by Tokyo Chemical Industry Co., Ltd.) . . . 4.0% by mass

Polymerizable monomer tribromophenoxyethyl acrylate (BR-31, produced by Dai-Ichi Kogyo Seiyaku Co., Ltd.) . . . 7.3% by mass

Photopolymerization initiator IRGACURE 784 (produced by Ciba Speciality Chemicals) . . . 0.74% by mass

Composition for Optical Recording (D)

Polypropylene glycol diglycidyl ether (Epolight 400P, produced by Kyoeisha Chemical Co., Ltd.) . . . 64% by mass

Methylcyclohexenedicarboxylic anhydride (EPICLON EXB-4400, produced by Dainippon Ink and Chemicals, Incorporated) . . . 24% by mass

Curing catalyst DBU (produced by Tokyo Chemical Industry Co., Ltd.) . . . 4.0% by mass

Polymerizable monomer tribromophenoxyethyl acrylate (BR-31, produced by Dai-Ichi Kogyo Seiyaku Co., Ltd.) . . . 7.3% by mass

Photopolymerization initiator IRGACURE 784 (produced by Ciba Speciality Chemicals) . . . 0.74% by mass

Composition for Optical Recording (E)

Polypropylene glycol diglycidyl ether (Epolight 400P, produced by Kyoeisha Chemical Co., Ltd.) . . . 64% by mass

Trimethylolpropane triglycidyl ether (Epolight 100MF, produced by Kyoeisha Chemical Co., Ltd.) . . . 4.0% by mass

Methylhexahydrophthalic anhydride (Rikacid MH-700, produced by New Japan Chemical Co., Ltd.) . . . 20% by mass

Curing catalyst DBU (produced by Tokyo Chemical Industry Co., Ltd.) . . . 4.0% by mass

Polymerizable monomer tribromophenoxyethyl acrylate (BR-31, produced by Dai-Ichi Kogyo Seiyaku Co., Ltd.) . . . 7.3% by mass

Photopolymerization initiator IRGACURE 784 (produced by Ciba Speciality Chemicals) . . . 0.74% by mass

Composition for Optical Recording (F)

Polypropylene glycol diglycidyl ether (Epolight 400P, produced by Kyoeisha Chemical Co., Ltd.) . . . 71% by mass

Methylcyclohexenedicarboxylic anhydride (EPICLON EXB-4400, produced by Dainippon Ink and Chemicals, Incorporated) . . . 17% by mass

Curing catalyst tris(dimethylaminomethyl)phenol (produced by Tokyo Chemical Industry Co., Ltd.) . . . 4.0% by mass

Polymerizable monomer tribromophenoxyethyl acrylate (BR-31, produced by Dai-Ichi Kogyo Seiyaku Co., Ltd.) . . . 7.3% by mass

Photopolymerization initiator IRGACURE 784 (produced by Ciba Speciality Chemicals) . . . 0.74% by mass

Composition for Optical Recording (G)

Polypropylene glycol diglycidyl ether (Epolight 400P, produced by Kyoeisha Chemical Co., Ltd.) . . . 72% by mass

Di(2-aminoethyl)methylhexahydrophthalic diamide . . . 15% by mass

Curing catalyst tris(dimethylaminomethyl)phenol (produced by Sigma-Aldrich, Inc.) . . . 4.0% by mass

Polymerizable monomer tribromophenoxyethyl acrylate (BR-31, produced by Dai-Ichi Kogyo Seiyaku Co., Ltd.) . . . 7.3% by mass

Photopolymerization initiator IRGACURE 784 (produced by Ciba Speciality Chemicals) . . . 0.74% by mass

In Comparative Examples 1 to 3, compositions for optical recording were prepared using the following components, optical recording media were prepared in the same way as in Example 1, and the same evaluation as in Example 1 was conducted. Results are shown in Table 9.

Composition for Optical Recording (V)

Polyethylene glycol diglycidyl ether (Epolight 400E, produced by Kyoeisha Chemical Co., Ltd.) . . . 64% by mass

Pentaerythritol tetramercaptopropionate (produced by Sigma-Aldrich, Inc.) . . . 24% by mass

Curing catalyst tris(dimethylaminomethyl)phenol (produced by Sigma-Aldrich, Inc.) . . . 4.0% by mass

Polymerizable monomer tribromophenoxyethyl acrylate (BR-31, produced by Dai-Ichi Kogyo Seiyaku Co., Ltd.) . . . 7.3% by mass

Photopolymerization initiator IRGACURE 784 (produced by Ciba Speciality Chemicals) . . . 0.74% by mass

Composition for Optical Recording (W)

Polyethylene glycol diglycidyl ether (Epolight 400E, produced by Kyoeisha Chemical Co., Ltd.) . . . 82% by mass

Triethylene tetramine (produced by Sumitomo Chemical Co., Ltd.) . . . 6% by mass

Curing catalyst DBU (produced by Tokyo Chemical Industry Co., Ltd.) . . . 4.0% by mass

Polymerizable monomer tribromophenoxyethyl acrylate (BR-31, produced by Dai-Ichi Kogyo Seiyaku Co., Ltd.) . . . 7.3% by mass

Photopolymerization initiator IRGACURE 784 (produced by Ciba Speciality Chemicals) . . . 0.74% by mass

Composition for Optical Recording (X)

Isocyanate prepolymer BAYTECH WE-180 (produced by Bayer AG) . . . 15.7% by mass

Isocyanate prepolymer MONDUR ML (produced by Bayer AG) . . . 15.7% by mass

Tribromophenyl acrylate . . . 3.57% by mass

IRGACURE 784 . . . 0.77% by mass

3,5-di-tertiary-butyl-4-hydroxytoluene . . . 0.02% by mass

Polypropylene oxide triol (average molecular weight 1,000) . . . 63.3% by mass

Tertiary-butyl peroxide . . . 0.01% by mass

Tin dibutyl laurate . . . 0.98% by mass

TABLE 9

| | | Ratio of | | | | | | |
|---|---|---|---|---|---|---|---|---|
| | | epoxy | | | | | | |
| | Composition | compound | | | Heat | | Layer | Interference |
| | for optical | and curing | | Viscosity after | generation | Layer | thickness | pattern |
| | recording | agent | Odor | 30 minutes | with time | State | (mm) | writing |
| Example 1 | A | 1.11 | None | 101 | None | No failure | 199 | Good |
| Example 2 | B | 1.29 | None | 90 | None | No failure | 201 | Good |
| Example 3 | C | 0.71 | None | 140 | None | No failure | 200 | Good |
| Example 4 | D | 1.21 | None | 97 | None | No failure | 199 | Good |
| Example 5 | E | 1.11 | None | 104 | None | No failure | 200 | Good |
| Example 6 | F | 1.11 | None | 124 | None | No failure | 200 | Good |
| Example 7 | G | 1.09 | None | 115 | None | No failure | 201 | Good |
| Comp. Example 1 | V | 0.9 | Peculiar odor | 535 | Heat generation | No failure | 201 | Good |
| | | | | | after 25 minutes | | | |
| Comp. Example 2 | W | 1.05 | Peculiar odor | 310 | None | No failure | 198 | Good |
| Comp. Example 3 | X | (Isocyanate) | None | >1,000 (gelated) | Heat generation | —(*) | —(*) | —(*) |
| | | | | | after 1minute | | | |

(*)no data due to the failure of preparation

The results shown in Table 9 indicates that in the case of compositions for optical recording of Examples 1 to 7 in which polypropylene glycol diglycidyl ether and a curing agent were employed, the thickness of the recording layer could be made thick easily, and failure due to, for example, air bubbles did not take place in the layer.

In contrast, it was found that in Comparative Examples 1 and 2, no failure was found in the layer, but unfavorable peculiar odor was emitted. It was confirmed that in Comparative Example 3, there was no peculiar odor, but the layer did not become cured.

The invention can solve conventional problems and can provide: an excellent composition for optical recording which can form easily a recording layer with a thickness enabling high multiplexing recording, of which coating solution is easily managed, and which does not bring a foul smell and is not environmentally toxic; and an optical recording medium that includes such composition for optical recording.

The composition for optical recording of the invention is a composition for optical recording enabling high multiplexing recording and is suitably used as a photosensitive material which can achieve high multiplexing recording of an interference image formed by the information light and the reference light.

The optical recording medium of the invention is widely used as a variety of holographic optical recording media that can achieve high multiplexing recording of an interference image formed by the information light and the reference light.

What is claimed is:

1. A composition for optical recording comprising:
a matrix polymer formed by mixing an epoxide compound and a curing agent;
a polymerizable monomer having an unsaturated carbon bond; and
a photopolymerization initiator,
wherein the curing agent comprises at least one selected from a carboxylic acid, a carboxylic anhydride, a polyamide, a blocked compound of carboxylic compound, a blocked compound of carboxylic anhydride, a blocked compound of polyamide compound, a carboxylic acid derivative, a carboxylic anhydride derivative, and a polyamide derivative.

2. The composition for optical recording according to claim 1, wherein the epoxide compound comprises glycidyl ethers, glycidyl esters, glycidyl amines, alkyl oxides which are synthesized by the oxidation of unsaturated hydrocarbon, and derivatives of these compounds.

3. The composition for optical recording according to claim 1, wherein the polymerizable monomer comprises at least one selected from an unsaturated carboxylic ester compound, an unsaturated carboxylic amide compound, a styrene compound, a vinyl ether compound, and a vinyl ester compound.

4. The composition for optical recording according to claim 1, wherein the photopolymerization initiator comprises at least one of a photosensitive radical polymerization initiator and a photosensitive cationic polymerization initiator.

5. The composition for optical recording according to claim 1, wherein a content of the polymerizable monomer in the total solid components of the composition for optical recording is 1% by mass to 20% by mass, and a content of the photopolymerization initiator in the total solid components of the composition for optical recording is 0.1% by mass to 10% by mass.

6. An optical recording medium comprising a recording layer which comprises a composition for optical recording,
wherein the composition for optical recording comprises:
a matrix polymer formed by mixing an epoxide compound and a curing agent;
a polymerizable monomer having an unsaturated carbon bond; and
a photopolymerization initiator,
wherein the curing agent comprises at least one selected from a carboxylic acid, a carboxylic anhydride, a polyamide, a blocked compound of carboxylic compound, a blocked compound of carboxylic anhydride, a blocked compound of polyamide compound, a carboxylic acid derivative, a carboxylic anhydride derivative, and a polyamide derivative.

7. The optical recording medium according to claim 6, further comprising:
a first substrate;
a filter layer; and
a second substrate,
wherein the first substrate, the recording layer, the filter layer, and the second substrate are arranged in this order.

8. The optical recording medium according to claim 6, wherein the filter layer admits light of first wavelength and reflects light of second wavelength.

9. An optical recording method comprising:
applying information light and reference light, which are coherent, onto an optical recording medium;
forming an interference image by means of the information light and the reference light; and
recording the interference image on the optical recording medium,
wherein the optical recording medium comprises a recording layer which comprises a composition for optical recording,
wherein the composition for optical recording comprises:
a matrix polymer formed by mixing an epoxide compound and a curing agent;
a polymerizable monomer having an unsaturated carbon bond; and
a photopolymerization initiator,
wherein the curing agent comprises at least one selected from a carboxylic acid, a carboxylic anhydride, a polyamide, a blocked compound of carboxylic compound, a blocked compound of carboxylic anhydride, a blocked compound of polyamide compound, a carboxylic acid derivative, a carboxylic anhydride derivative, and a polyamide derivative.

10. The optical recording method according to claim 9, wherein the information light and the reference light are applied onto the optical recording medium in such a way that the optical axis of the information light is collinear with that of the reference light, the information light and the reference light interfere with each other to form an interference image, and the interference image is recorded on the optical recording medium.

11. An optical recording apparatus, wherein information light and reference light, which are coherent, are applied onto an optical recording medium, an interference image is formed by means of the information light and the reference light, and the interference image is recorded on the optical recording medium,
wherein the optical recording medium comprises a recording layer which comprises a composition for optical recording,
wherein the composition for optical recording comprises:
a matrix polymer formed by mixing an epoxide compound and a curing agent;
a polymerizable monomer having an unsaturated carbon bond; and
a photopolymerization initiator,
wherein the curing agent comprises at least one selected from a carboxylic acid, a carboxylic anhydride, a polyamide, a blocked compound of carboxylic compound, a blocked compound of carboxylic anhydride, a blocked compound of polyamide compound, a carboxylic acid derivative, a carboxylic anhydride derivative, and a polyamide derivative.

12. A method for producing an optical recording medium, comprising the steps of:
preparing a composition for optical recording; and
disposing a recording layer, which comprises the composition for optical recording, on a base material, wherein the composition for optical recording
wherein the composition for optical recording comprises:
a matrix polymer formed by mixing an epoxide compound and a curing agent;
a polymerizable monomer having an unsaturated carbon bond; and
a photopolymerization initiator,
wherein the curing agent comprises at least one selected from a carboxylic acid, a carboxylic anhydride, a polyamide, a blocked compound of carboxylic compound, a blocked compound of carboxylic anhydride, a blocked compound of polyamide compound, a carboxylic acid derivative, a carboxylic anhydride derivative, and a polyamide derivative.
